(19) United States
(12) Patent Application Publication
(10) Pub. No.: US 2024/0042546 A1
(43) Pub. Date: Feb. 8, 2024

(54) LASER PROCESSING MACHINE

(71) Applicants: Mitsubishi Electric Corporation, Tokyo (JP); TADA ELECTRIC CO., LTD., Hyogo (JP)

(72) Inventors: Kazuki KUBA, Tokyo (JP); Akihiro UENO, Hyogo (JP); Toshinobu EGUCHI, Hyogo (JP); Masaru YOSHIDA, Hyogo (JP); Junji MIYATA, Hyogo (JP)

(73) Assignees: Mitsubishi Electric Corporation, Tokyo (JP); TADA ELECTRIC CO., LTD., Hyogo (JP)

(21) Appl. No.: 18/377,394

(22) Filed: Oct. 6, 2023

Related U.S. Application Data
(63) Continuation of application No. 16/649,985, filed on Mar. 24, 2020, now abandoned.

(30) Foreign Application Priority Data
Oct. 17, 2017 (JP) 2017-201056

(51) Int. Cl. B23K 26/06; B23K 26/046; B23K 26/073; G02B 27/09

(52) U.S. Cl. CPC B23K 26/0648; B23K 26/046; B23K 26/0643; B23K 26/073; G02B 27/0927; B23K 26/0665

(57) ABSTRACT

A laser processing machine to perform laser processing by focusing a laser beam onto a workpiece, includes a light-focusing optical system to focus the laser beam, wherein the light-focusing optical system has an aberration, and a lateral aberration with respect to a laser beam diameter:D_{86.5} containing 86.5% of the laser power of a laser beam before being focused is 0.2 mm or more, the lateral aberration being at a light focusing point relative to a light beam corresponding to the laser beam diameter:D_{86.5}.

### CROSS-REFERENCE TO RELATED APPLICATIONS

The present application is a continuation of U.S. application Ser. No. 16/649,985, filed Mar. 24, 2020, which is based on PCT filing PCT/JP2018/037981, filed Oct. 11, 2018, which claims priority to JP 2017-201056, filed Oct. 17, 2017, the entire contents of each are incorporated herein by reference.

### FIELD

The present invention relates to a laser processing machine that performs laser processing by using a laser beam, such as cutting, welding, and heat treatment.

### BACKGROUND

Because a conventional laser processing machine that performs laser processing using a laser beam, such as metal cutting, welding, and heat treatment, needs to generate highly-focused high-output laser beams, a CO₂ laser is mainly used that is a mid-infrared laser with a wavelength of approximately 9 to 10 μm. In recent years, near-infrared lasers that output a laser beam within a near-infrared wavelength range, such as a fiber laser, a disk YAG (Yttrium Aluminum Garnet) laser, and a direct diode laser, have become increasingly advanced with more highly-focused higher-output laser beams. Along with the advancement of the near-infrared lasers with more highly-focused higher-output laser beams, a laser processing machine using a near-infrared laser as a light source is being further developed.

When a workpiece is irradiated with a laser beam from a laser processing machine, a portion of the workpiece irradiated with the laser beam instantaneously melts and evaporates, thereby forming a keyhole with its periphery surrounded by molten metal. Convection of the molten metal occurs inside the keyhole. If the molten metal flows toward an opening of the keyhole at an increased speed, a part of the molten metal may spatter from the opening of the keyhole. The spattering molten metal is called spatter. When spatters are produced, the spatters adhere to the periphery of the machined portion, which degrades the processing quality of the workpiece. A laser processing machine using a near-infrared laser has a problem in that spatters are more likely to be produced and thus the processing quality of a workpiece tends to be degraded as compared to a laser processing machine using a CO₂ laser.

Patent Literature 1 discloses a laser processing machine including an optical unit that forms a main beam and a sub-beam with a larger diameter and lower energy than the main bean, in order to minimize degradation in the processing quality of a workpiece. The optical unit includes a collimate lens, a light-focusing lens, and a perforated concave lens.

### CITATION LIST

### Patent Literature

Patent Literature 1: Japanese Patent Application Laid-open No. 2003-340582

### SUMMARY

### Technical Problem

However, in Patent Literature 1 mentioned above, there is no description that the laser processing machine can identify the light-focusing state of a laser beam to be irradiated onto a workpiece. There is thus a problem in that the shape of a keyhole cannot be stabilized depending on the light-focusing state, and this may lead to degradation in the processing quality of the workpiece.

The present invention has been devised to solve the above problems, and an object of the present invention is to provide a laser processing machine that can stabilize the processing quality.

### Solution to Problem

In order to solve the above problems and achieve the object, a laser processing machine according to the present invention includes: a light-focusing optical system to focus the laser beam onto a workpiece for performing a laser processing, wherein the light-focusing optical system has an aberration, and a lateral aberration with respect to a laser beam diameter:D_{86.5} containing 86.5% of the laser power of a laser beam before being focused is 0.2 mm or more, the lateral aberration being at a light focusing point relative to a light beam corresponding to the laser beam diameter:D_{86.5}.

### Advantageous Effects of Invention

According to the present invention, there is an effect where the processing quality can be stabilized in laser processing.

### BRIEF DESCRIPTION OF DRAWINGS

FIG. 1 is a diagram illustrating a schematic configuration of a laser processing machine according to a first embodiment of the present invention.

FIG. 2 is an enlarged diagram of a beam shape of a focused light beam illustrated in FIG. 1.

FIG. 3 is a diagram illustrating a state of a workpiece when laser processing is performed using the laser processing machine illustrated in FIG. 1.

FIG. 4 is a diagram illustrating a state of a workpiece when laser processing is performed using a laser processing machine according to a first comparative example of the present invention.

FIG. 5 is a diagram illustrating a state of a workpiece when laser processing is performed using a laser processing machine according to a second comparative example of the present invention.

FIG. 6 is a light beam diagram of a laser beam emitted by the laser processing machine illustrated in FIG. 1.

FIG. 7 is a diagram illustrating a laser-light intensity distribution corresponding to each of an optical-axis position −12 to an optical-axis position −6 illustrated in FIG. 6.

FIG. 8 is a diagram illustrating a laser-light intensity distribution corresponding to each of an optical-axis position −4 to an optical-axis position +2 illustrated in FIG. 6.

FIG. 9 is a diagram illustrating each state during and after welding processing at the optical-axis position −12 to the optical-axis position −6 illustrated in FIG. 6.

FIG. 10 is a diagram illustrating each state during and after welding processing at the optical-axis position −4 to the optical-axis position +2 illustrated in FIG. 6.

FIG. 11 is a light beam diagram of a laser beam emitted by a laser processing machine according to a third comparative example of the present invention.

FIG. 12 is a diagram illustrating a laser-light intensity distribution corresponding to each of an optical-axis position −8 to an optical-axis position −2 illustrated in FIG. 11.

FIG. 13 is a diagram illustrating a laser-light intensity distribution corresponding to each of an optical-axis position 0 to an optical-axis position +6 illustrated in FIG. 11.

FIG. 14 is a diagram illustrating each state during and after welding processing at the optical-axis position −8 to the optical-axis position −2 illustrated in FIG. 11.

FIG. 15 is a diagram illustrating each state during and after welding processing at the optical-axis position 0 to the optical-axis position +6 illustrated in FIG. 11.

FIG. 16 is a diagram illustrating conditions of a laser oscillator and an optical system of a laser processing machine in a first experiment example of the present invention.

FIG. 17 is a diagram illustrating experiment conditions according to a second experiment example of the present invention.

FIG. 18 is a diagram illustrating results of laser processing performed under the conditions illustrated in FIG. 17.

FIG. 19 is a graph illustrating transition of a spatter generation relative to variations in a lateral aberration in the entire optical system illustrated in FIGS. 17 and 18.

FIG. 20 is a graph illustrating transition of a peripheral molten-pool width when the lateral aberration is varied under the conditions illustrated in FIG. 17.

FIG. 21 is a graph illustrating transition of a spatter generation when a peripheral molten-pool width illustrated in FIG. 18 is varied.

FIG. 22 is a diagram illustrating dependence of lateral-aberration on input-surface curvature for a simple lens to be examined in the third experiment example intended for identifying the characteristics required for the light-focusing lens 32 in FIG. 1.

FIG. 23 is a diagram illustrating transition of an output-surface curvature relative to variations in an input-surface curvature.

FIG. 24 is a diagram illustrating the shape of a light-focusing lens and light beams according to the third experiment example of the present invention.

FIG. 25 is a diagram illustrating a partially enlarged view of FIG. 24 and a lateral aberration corresponding to the enlarged view.

FIG. 26 is a diagram illustrating conditions of a processing optical system according to a fourth experiment example of the present invention.

FIG. 27 is a light beam diagram and a schematic configuration diagram of a processing optical system under the conditions illustrated in FIG. 26.

FIG. 28 is a diagram illustrating an example of product specifications of a near-infrared laser light source used in the first to fourth experiment examples.

FIG. 29 is a diagram illustrating conditions of a laser processing machine in a fifth experiment example of the present invention.

FIG. 30 is a light beam diagram and a diagram illustrating an intensity distribution of laser light emitted by the laser processing machine under each of the conditions illustrated in FIG. 29.

FIG. 31 is a diagram illustrating conditions of a laser processing machine in a sixth experiment example of the present invention.

FIG. 32 is a light beam diagram and a diagram illustrating an intensity distribution of laser light emitted by the laser processing machine under each of the conditions illustrated in FIG. 31.

FIG. 33 is a diagram illustrating conditions of an aberration of each lens in a seventh experiment example of the present invention.

FIG. 34 is a diagram illustrating experiment results of an eighth experiment example of the present invention.

FIG. 35 is a diagram illustrating experiment results of a ninth experiment example of the present invention.

FIG. 36 is a diagram illustrating a configuration of a laser processing machine according to a second embodiment of the present invention.

### DESCRIPTION OF EMBODIMENTS

A laser processing machine according to embodiments of the present invention will be described in detail below with reference to the accompanying drawings. The present invention is not limited to the embodiments.

### First Embodiment

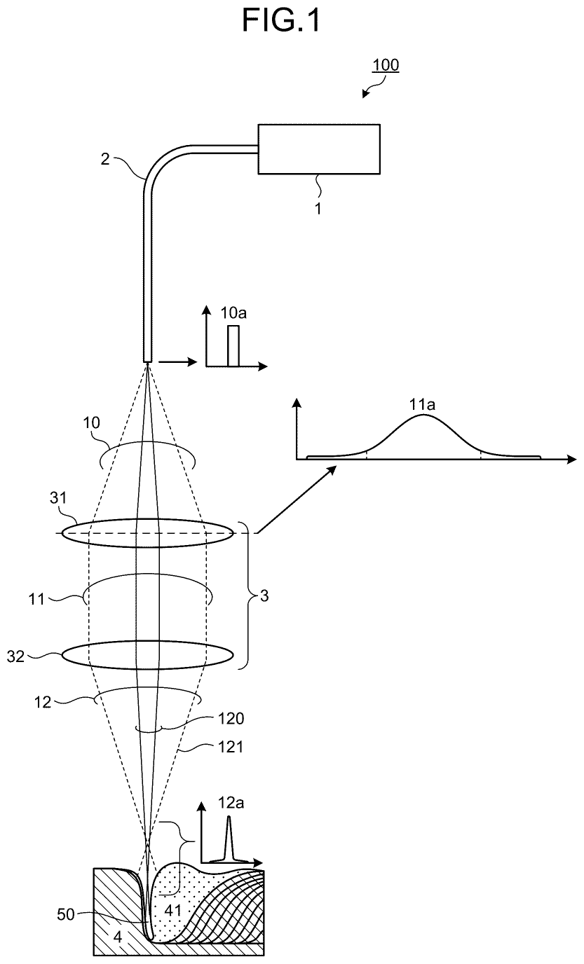

FIG. 1 is a diagram illustrating a schematic configuration of a laser processing machine 100 according to a first embodiment of the present invention. The laser processing machine 100 includes a laser oscillator 1, an optical fiber 2, and a light-focusing optical system 3.

The laser oscillator 1 is a near-infrared laser light source that emits laser light within a near-infrared wavelength range, such as a fiber laser, a disk YAG laser, or a direct diode laser. The optical fiber 2 transmits laser light emitted by the laser oscillator 1. An emitted beam 10 that is a laser beam emitted from the optical fiber 2 is incident to the light-focusing optical system 3. The light-focusing optical system 3 includes a collimate lens 31 and a light-condensing lens 32. The collimate lens 31 collimates the emitted beam 10 to generate collimated light 11. The collimated light 11 is incident to the light-condensing lens 32. The light-focusing lens 32 irradiates a focused light beam 12 obtained by focusing the collimated light 11 onto a workpiece 4. The workpiece 4 is an iron material to be processed. When the focused light beam 12 is irradiated onto the workpiece 4, the workpiece 4 melts and evaporates, thereby forming a keyhole 50 with its periphery surrounded by a molten metal 41. Laser processing is performed while changing the irradiating position of the focused light beam 12 onto the workpiece 4. At least one of the collimate lens 31 and the light-focusing lens 32 has an aberration. The light-focusing optical system 3 has an aberration in its entirety. Due to this aberration of the light-focusing optical system 3, as compared to a light-focusing point of a focused light beam 120 in a paraxial region where the full angle of fiber emission is equal to or smaller than 10°, a focused light beam 121 at a light-beam position corresponding to a diameter D_{86.5} of a laser beam containing 86.5% of laser power is focused on the trailing side in the beam traveling direction, and becomes defocused at the light-focusing position in the paraxial region without being focused.

A beam shape 10a of the emitted beam 10 is a flat-top shape with uniform laser power and a certain width with respect to an optical axis as the center, where the horizontal axis represents a position on the axis perpendicular to the optical axis, and where the vertical axis represents a light intensity. Hereinafter, in the description of the beam shape, the horizontal axis represents a position on the axis perpendicular to the optical axis, while the vertical axis represents a light intensity. A beam shape 11a of the collimated light 11 of the collimate lens 31 at the optical-axis position is a Gaussian distribution shape with a peak on the optical axis. A beam shape 12a of the focused light beam 12 emitted from the light-focusing lens 32 has a peak on the optical axis, and the light intensity tails off as the position on the horizontal axis becomes farther from the optical axis. In the specification of the present invention, the beam shape including an inverted-V shape at the central portion and becoming wider toward the peripheral portion so as to form a gentle slope is referred to as “witch hat shape”.

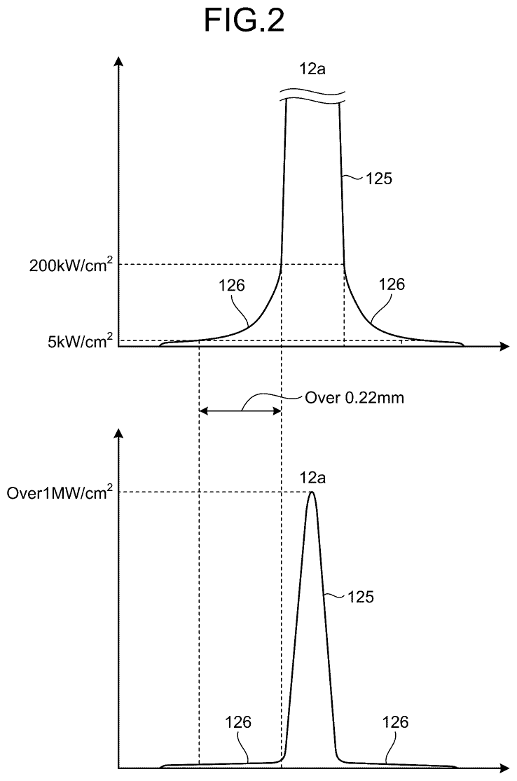

FIG. 2 is an enlarged diagram of the beam shape 12a of the focused light beam 12 illustrated in FIG. 1. Due to the aberration of the light-focusing optical system 3, the beam shape 12a of the focused light beam 12 becomes a witch hat shape at and around the light-focusing point of the light-focusing optical system 3. When a plane perpendicular to the optical axis is viewed, the focused light beam 12 at the light-focusing position is constituted by a substantially circular main beam 125 having the optical axis as the center, and an annular peripheral beam 126 surrounding the main beam 125. The main beam 125 has a light intensity of, for example, 1 MW/cm² or higher. The peripheral beam 126 has a lower light intensity than the main beam 125. The peripheral beam 126 is herein defined as a portion having a light intensity of 5 kW/cm² or higher and 200 kW/cm² or lower. The peripheral beam 126 is a portion equivalent to the brim of a witch hat-shaped hat, and forms a gentle slope extending from the main beam 125. The peripheral beam 126 has a doughnut shape surrounding the main beam 125 when viewed in cross section perpendicular to the optical axis. It is desirable that the peripheral beam 126 has a width of 0.22 mm or greater.

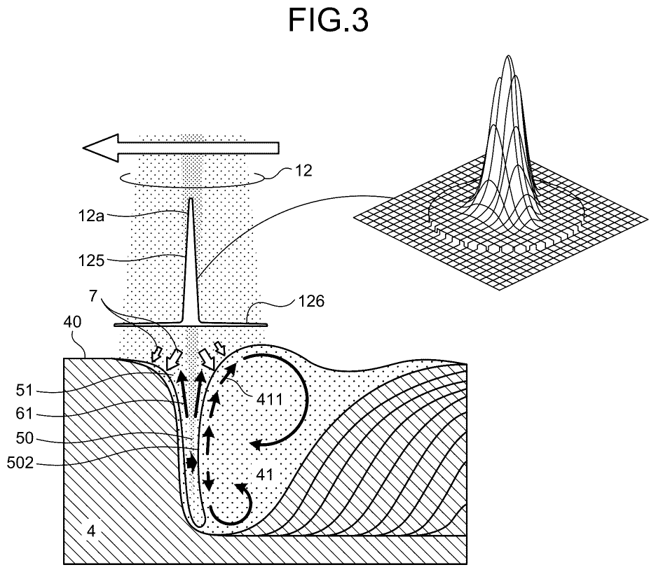

FIG. 3 is a diagram illustrating a state of a workpiece 4 when laser processing is performed using the laser processing machine 100 illustrated in FIG. 1. FIG. 3 illustrates laser welding as an example. The laser processing machine 100 scans the focused light beam 12 in the leftward direction in FIG. 3.

The beam shape 12a of the focused light beam 12 is a witch hat shape. The main beam 125 at the central portion melts metal of the workpiece 4 and forms the keyhole 50. The peripheral beam 126 evaporates the surface of the molten metal 41 and produces metal steam 61. At an opening 51 of the keyhole 50, an evaporation reaction force 7 of the metal steam 61 becomes a force directed from the surface of the molten metal 41 toward the interior of the workpiece 4. On the trailing side in the laser-light scanning direction, the evaporation reaction force 7 causes the direction of a molten metal flow 411, moving upward along a keyhole inner wall 502, to change from a direction vertical to a surface 40 of the workpiece 4 to a direction parallel to the surface 40. Due to this direction change, the opening 51 of the keyhole 50 becomes widened into a bell-mouth shape. The molten metal flow 411 becomes a flow directed toward the interior of the workpiece 4. This reduces production of spatters. Because spatters are more likely to be generated on the trailing side in the laser-light scanning direction, it is important to form the peripheral beam 126 on the trailing side in the laser-light scanning direction.

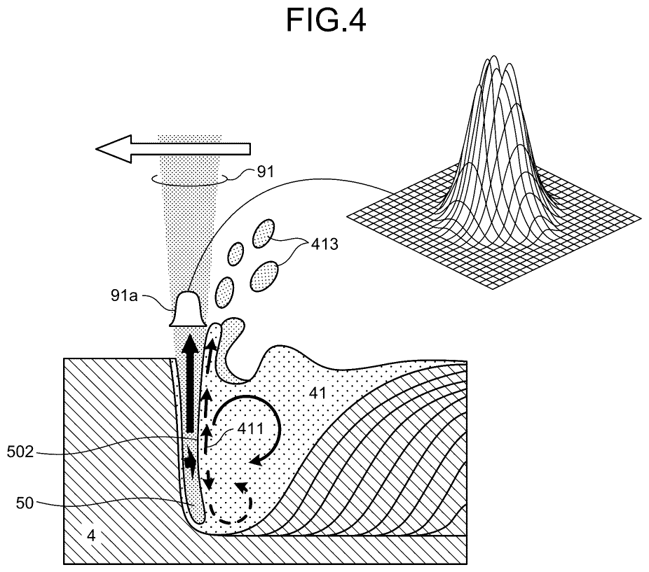

FIG. 4 is a diagram illustrating a state of the workpiece 4 when laser processing is performed using a laser processing machine according to a first comparative example of the present invention. In a laser processing machine using a near-infrared laser light source, in a case where a light-focusing optical system has a small aberration or does not have an aberration, a beam shape 91a of a focused light beam 91 in the vicinity of the light-focusing point becomes substantially a flat-top shape. The flat-top shape is obtained by enlarging the beam shape at the emission end of the optical fiber 2 in a cross-sectional direction by an optical magnification α=f_{f}/f_{c} that is determined by the ratio between a focal distance f_{c} of the collimate lens 31 and a focal distance f_{f} of the light-focusing lens 32.

In the example in FIG. 4, in the beam shape 91a of the focused light beam 91, a peripheral beam is not present around the main beam. The light intensity does not tail off from the top, but sharply decreases to 5 kW/cm² or lower. For this reason, the keyhole inner wall 502 has a shape that extends in almost a vertical state relative to the surface of the workpiece 4 continuously from the interior of the keyhole 50 to the surface of the workpiece 4. The molten metal flow 411 is hardly directed toward the interior of the workpiece 4. The molten metal flow 411 is directed toward the opening of the keyhole 50 at a higher speed, and thus a part of the molten metal 41 spatters. This produces spatters 413.

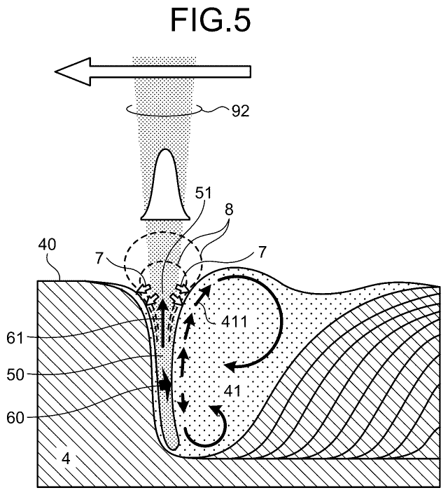

FIG. 5 is a diagram illustrating a state of the workpiece 4 when laser processing is performed using a laser processing machine according to a second comparative example of the present invention. In the second comparative example, the laser processing machine uses a CO₂ laser instead of a near-infrared laser light source. The CO₂ laser is a mid-infrared laser with a wavelength around 9 μm to 10 μm. Thus, the CO₂ laser has a higher absorption rate for plasma produced by interaction between metal steam 60 and 61 and laser light. When the CO₂ laser irradiates a focused light beam 92 onto the workpiece 4, high-temperature plasma 8 is generated in the keyhole 50 and the opening 51 of the keyhole 50. In laser processing using a CO₂ laser, the high-temperature plasma 8 heats metal near the opening 51 and the metal evaporates. The evaporation reaction force 7 causes the opening 51 to moderately become widened. For this reason, when a CO₂ laser is used, the molten metal flow 411 tends to be directed toward the interior of the workpiece 4 without adjusting the aberration of the light-focusing optical system. This reduces the production of the spatters 413 and can maintain stable machining quality. Therefore, in a laser processing machine using a near-infrared laser light source, the light-focusing optical system 3 that forms the focused light beam 12 with the beam shape 12a illustrated in FIG. 2 is used to thereby heat and enlarge the keyhole opening equivalent to heating and enlarging the keyhole opening by using plasma in CO₂ laser processing. It is thus possible to avoid the problem in that the spatters 413 are more likely to be produced when a near-infrared laser light source is used.

As explained below, experiments were performed as a first experiment example to a ninth experiment example using different optical elements under different conditions or the like in the laser processing machine 100 according to the first embodiment. The conditions for the laser processing machine 100 to reduce the spatters 413 and maintain satisfactory machining quality without causing any problem in practical use were then examined.

### First Experiment Example

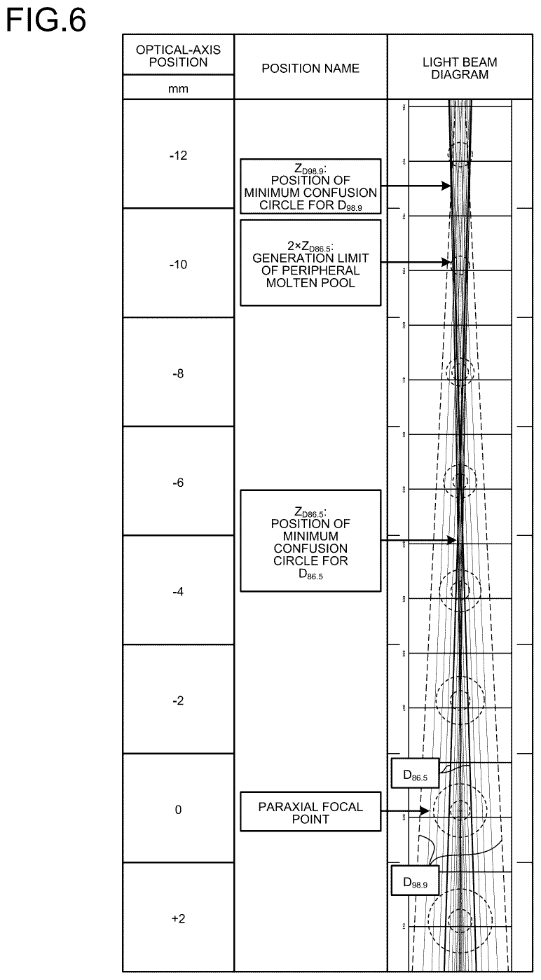

FIG. 6 is a light beam diagram of a laser beam emitted by the laser processing machine 100 illustrated in FIG. 1. The light beam diagram illustrates the optical-axis position and the name of representative optical-axis positions. The light beam diagram in FIG. 6 illustrates light beams generated at equal angular intervals from the center of the optical fiber 2. The thick solid line illustrates a light beam corresponding to a beam diameter D_{86.5} that is a diameter of a laser beam containing therein 86.5% of laser power. The dotted line illustrates a beam diameter that is 1.5 times larger than the beam diameter D_{86.5}, and corresponds to a beam diameter D_{98.9} that is a diameter of the laser beam containing therein 98.9% of laser power. Hereinafter, the diameter of a laser beam containing 86.5% of laser power is referred to as “beam diameter D_{86.5}”.

With respect to the paraxial focal position as the origin point, the optical-axis position is shown as a negative value when an upper portion of the laser beam is used for processing, while being shown as a positive value when a lower portion of the laser beam is used for processing. This follows the customary practice in the laser processing industry to show a focal position as a positive value when the focal position is present above the material surface.

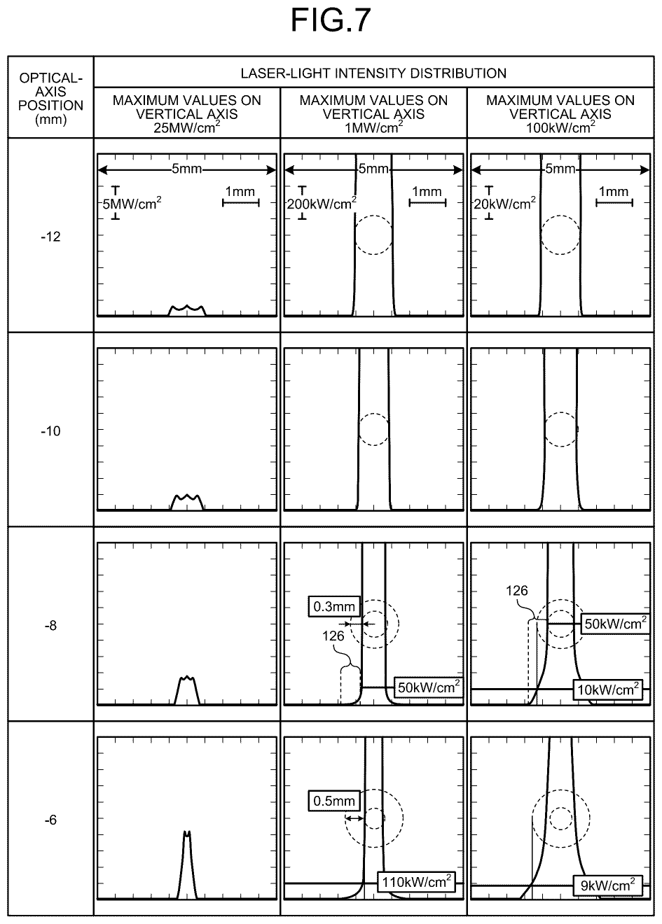

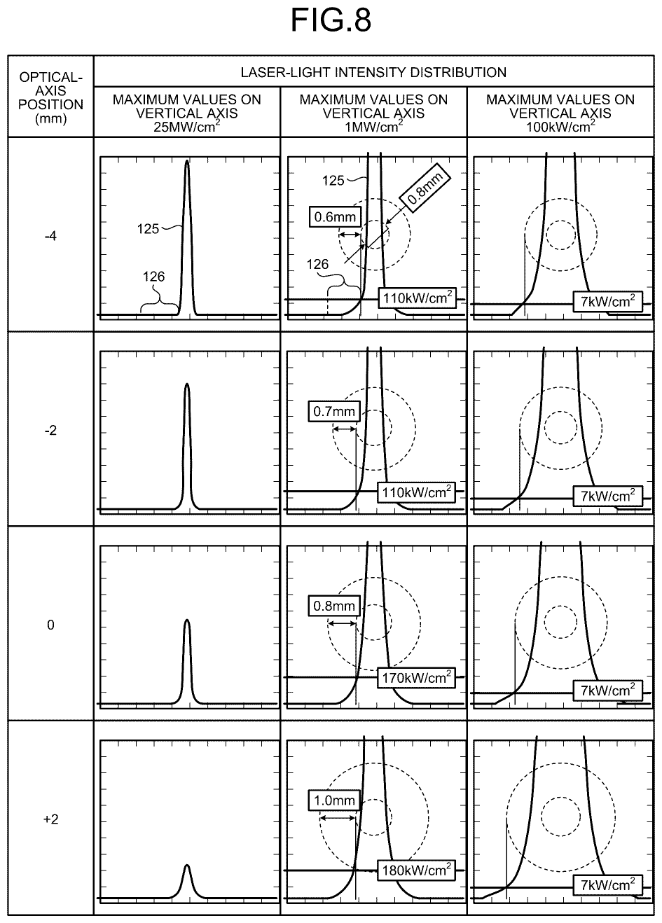

FIG. 7 is a diagram illustrating a laser-light intensity distribution corresponding to each of the optical-axis position −12 to the optical-axis position −6 illustrated in FIG. 6. FIG. 8 is a diagram illustrating a laser-light intensity distribution corresponding to each of the optical-axis position −4 to the optical-axis position +2 illustrated in FIG. 6.

FIGS. 7 and 8 illustrate laser-light intensity distributions corresponding to each of the optical-axis positions in three types of scales. These intensity distributions are results of simulation of a far field of the emitted beam 10 as a Gaussian distribution. FIGS. 7 and 8 illustrate the laser-light intensity distributions in three types of scales with different maximum values on the vertical axis at 25 MW/cm², 1 MW/cm², and 100 kW/cm². From the diagram in which the maximum value on the vertical axis is 25 MW/cm², the entire shape including the peak at the center can be acknowledged. From the diagrams in which the maximum value on the vertical axis is 1 MW/cm² and 100 kW/cm², a very weak peripheral beam 126 can be acknowledged.

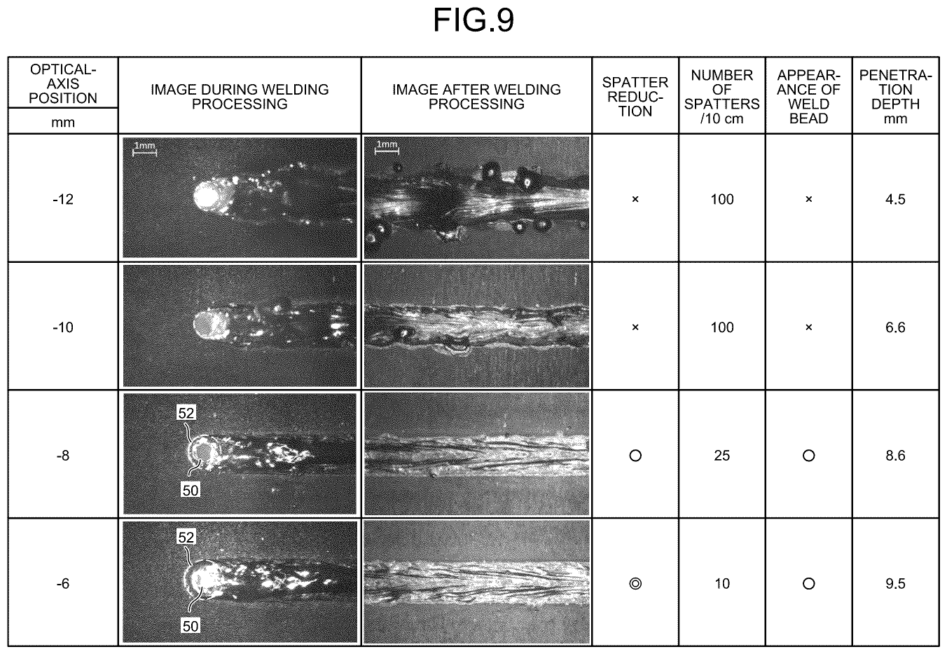

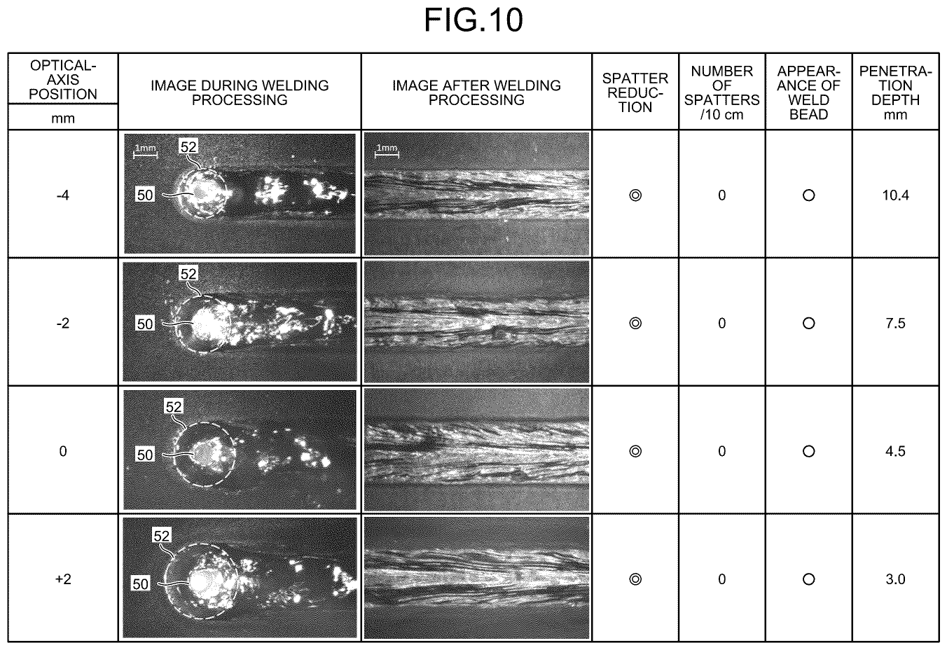

FIG. 9 is a diagram illustrating each state during and after welding processing at the optical-axis position −12 to the optical-axis position −6 illustrated in FIG. 6. FIG. 10 is a diagram illustrating each state during and after welding processing at the optical-axis position −4 to the optical-axis position +2 illustrated in FIG. 6.

FIGS. 9 and 10 illustrate an image during welding processing, an image after welding processing, whether spatters are reduced properly, the number of spatters generated per welding length of 10 cm, whether the appearance of the weld bead is acceptable, and a welding penetration depth corresponding to each of the optical-axis position −12 to the optical-axis position +2.

The image during welding processing is an image captured while welding processing is performed, and shows a state of the keyhole 50 and a peripheral molten pool 52. In the image during welding processing, occurrence of halation due to plume emission is avoided by using LD light and a line filter. Whether spatters are reduced properly is indicated by the symbol “●”, “◯”, or “x” in a descending order of the effect of reducing spatters produced. The appearance of the weld bead indicates the processing quality. Whether the surface bead looks good after welding processing is indicated by the symbol “◯” when the state of the surface bead is acceptable, while being indicated by the symbol “x” when the state of the surface bead is not acceptable.

The shape of a molten pool including the keyhole 50 and the peripheral molten pool 52, which are illustrated in the image during welding processing, shows a strong correlation with whether spatters are reduced properly. It is understood that at the optical-axis position −8 mm to the optical-axis position +2 mm, the peripheral molten pool 52 is present around the keyhole 50 being shallower than the keyhole 50, and within the range of these optical-axis positions, the spatters 413 are properly reduced. At the optical-axis position −12 mm to the optical-axis position −10 mm, the peripheral molten pool 52 is not formed around the keyhole 50. Because the keyhole 50 is not opened into a bell-mouth shape, the spatters 413 are produced. Referring to the image during welding processing at the optical-axis position −8 mm, it is understood that although the peripheral molten pool 52 is slightly formed, it is still effective to reduce the spatters 413. The peripheral molten pool 52 at the optical-axis position −8 mm has a width of only 0.3 mm, and is formed by the peripheral beam 126 with a light intensity that gradually decreases from 50 kW/cm² to 0 kW/cm² with reference to FIG. 7. It is understood that even under the conditions of the peripheral beam 126 as described above, it is still effective to reduce the spatters 413.

Next, a relation between a laser-light intensity distribution and the shape of a molten pool is described. Generation of a keyhole starts at a light intensity equal to higher than 110 kW/cm² and equal to or lower than 180 kW/cm². A section with a light intensity that falls within this range is defined as the keyhole 50, while the boundary of the keyhole 50 is defined as an inner diameter of the peripheral beam 126. The light intensity at a melting limit is equal to or higher than 7 kW/cm² and equal to lower than 20 kW/cm². The position of this melting limit is defined as an outer diameter of the peripheral beam 126. With reference to FIGS. 7 and 8, it is understood that the width of the peripheral beam 126, which is the difference between the inner diameter and the outer diameter of the peripheral beam 126, is 0.3 mm at the optical-axis position −8 mm, 0.5 mm at the optical-axis position −6 mm, 0.6 mm at the optical-axis position −4 mm, 0.7 mm at the optical-axis position −2 mm, 0.8 mm at the optical-axis position 0 mm, and 1.0 mm at the optical-axis position +2 mm.

The shape of the peripheral molten pool 52 in the image during welding processing illustrated in FIGS. 9 and 10 corresponds to the shape of the peripheral beam 126 illustrated in FIGS. 7 and 8, respectively. As a result of closely analyzing the laser-light intensity distribution for the image during welding processing on the basis of these diagrams, a correlation between the image and the laser-light intensity distribution has been clarified. There is a strong correlation between the laser-light intensity distribution and the metal melting phenomenon.

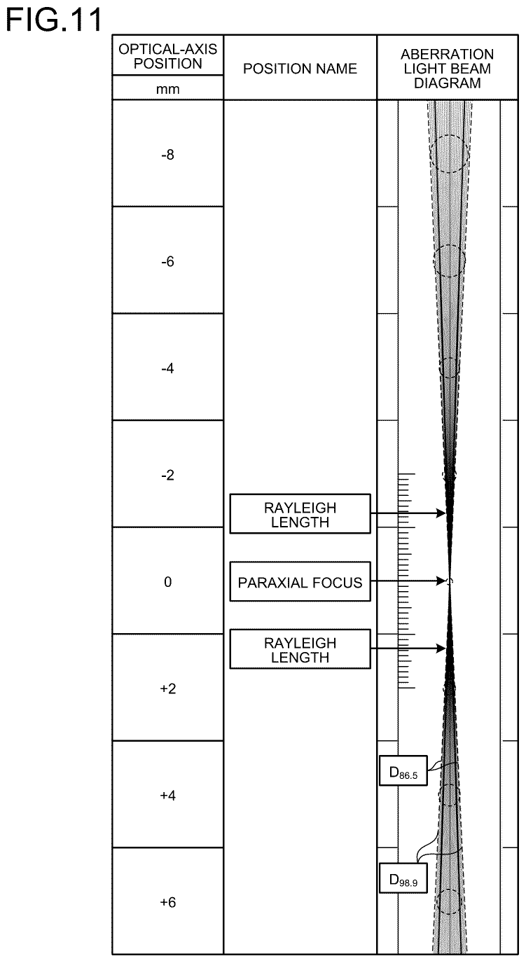

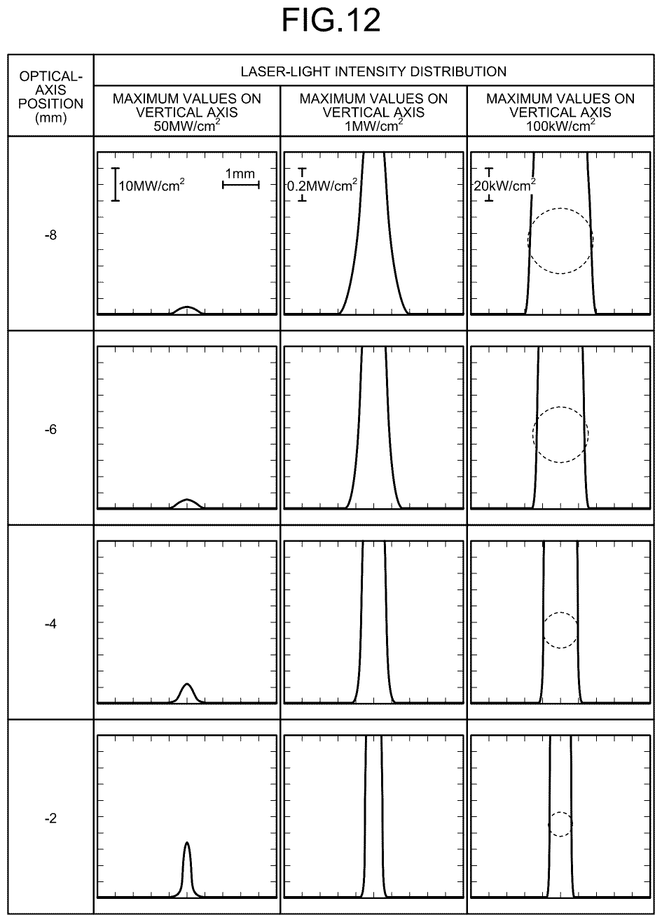

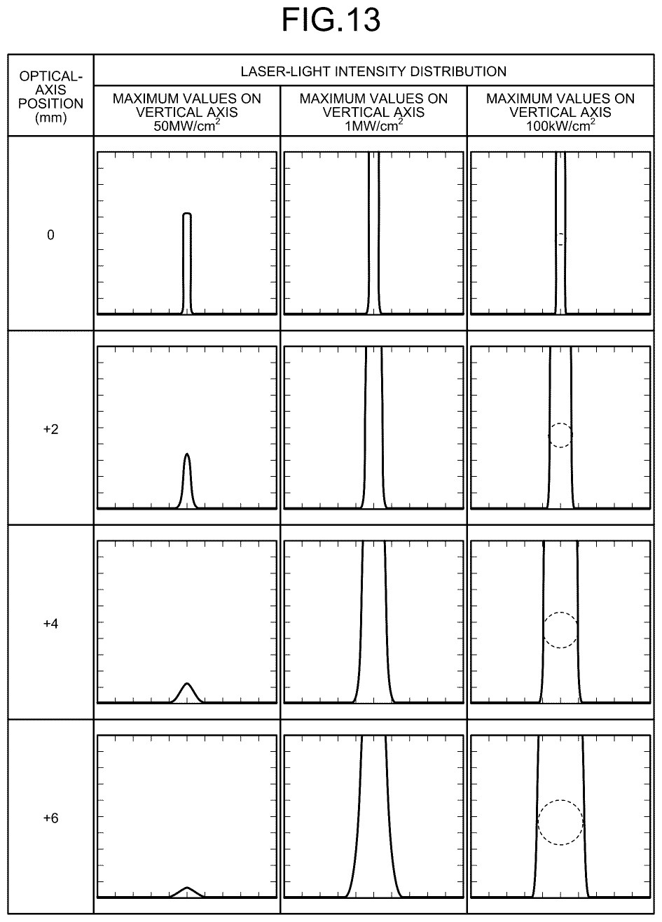

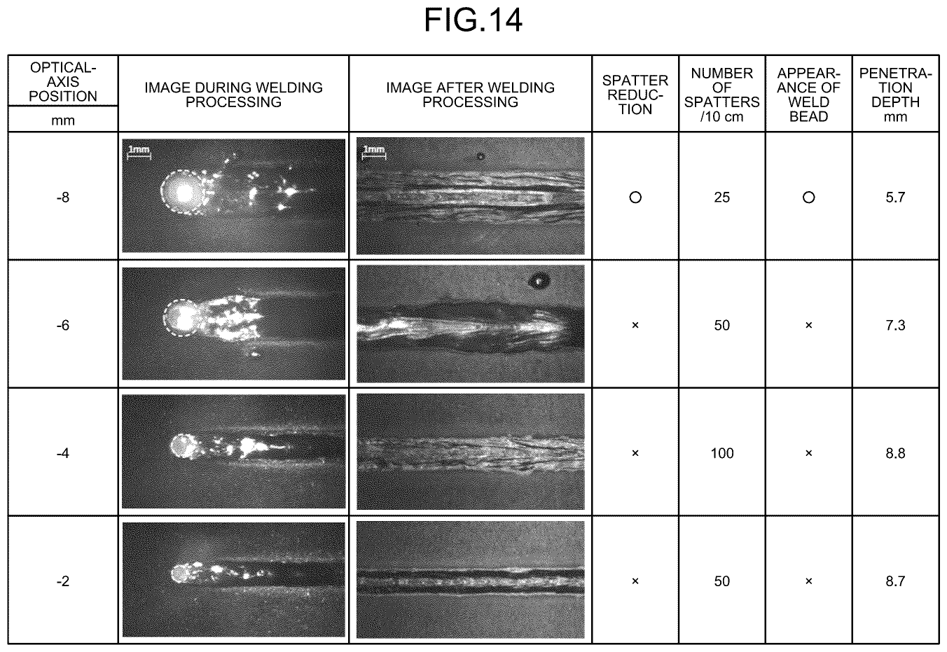

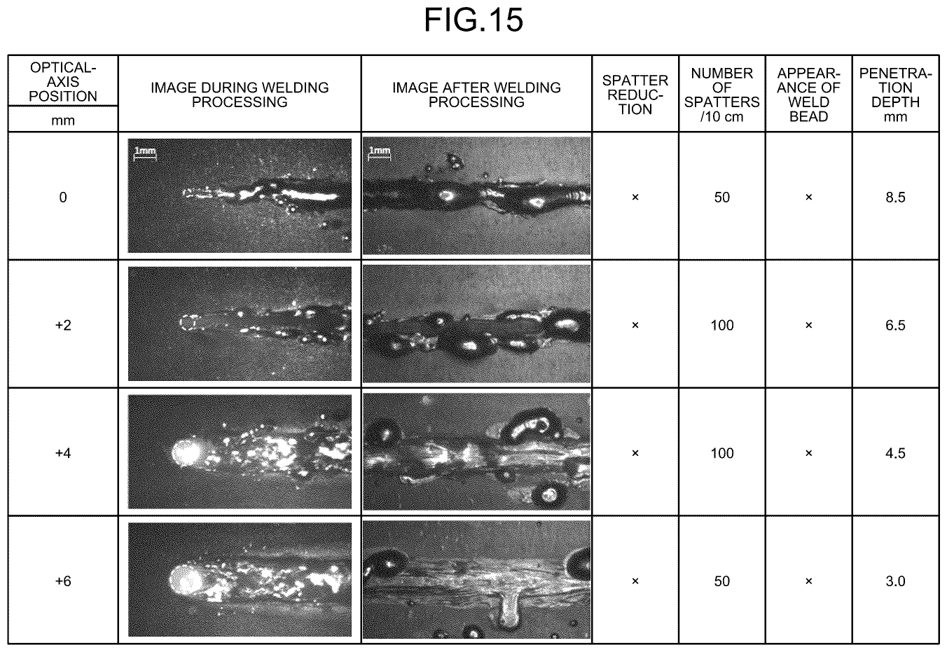

FIG. 11 is a light beam diagram of a laser beam emitted by a laser processing machine according to a third comparative example of the present invention. The laser processing machine according to the third comparative example uses a near-infrared laser light source and a general low-aberration light-focusing optical system. FIG. 12 is a diagram illustrating a laser-light intensity distribution corresponding to each of the optical-axis position −8 to the optical-axis position −2 illustrated in FIG. 11. FIG. 13 is a diagram illustrating a laser-light intensity distribution corresponding to each of the optical-axis position 0 to the optical-axis position +6 illustrated in FIG. 11. FIGS. 12 and 13 illustrate the laser-light intensity distributions in three types of scales with different maximum values on the vertical axis at 50 MW/cm², 1 MW/cm², and 100 kW/cm². FIG. 14 is a diagram illustrating each state during and after welding processing at the optical-axis position −8 to the optical-axis position −2 illustrated in FIG. 11. FIG. 15 is a diagram illustrating each state during and after welding processing at the optical-axis position 0 to the optical-axis position +6 illustrated in FIG. 11. The items in respective columns illustrated in FIGS. 11 to 15 are the same as those in the respective columns illustrated in FIGS. 6 to 10.

With reference to FIG. 11, in the laser processing machine according to the third comparative example of the present invention, a light beam is longitudinally symmetrical about the paraxial focal point that is the light-focusing condensing point. With reference to FIGS. 12 and 13, the intensity distribution on the outer side of the Rayleigh length shows substantially a Gaussian shape. As the optical-axis position is farther from the light-focusing point, the beam diameter increases linearly, while the light intensity decreases in inverse proportion to the square of the defocus distance. In the vicinity of the light-focusing point within the Rayleigh length, due to image transfer of the light intensity distribution at the emission end of the optical fiber 2, the beam shape becomes a flat-top-like shape, and then becomes a flat-top shape at and around the paraxial focal point that is the light-focusing point.

In contrast to the third comparative example illustrated in FIGS. 11 to 13, in the first embodiment of the present invention, the light-focusing optical system 3 has an aberration. Accordingly, as illustrated in FIGS. 6 to 8, the laser beam diagram shows complicated propagation characteristics in that the shape itself of the laser-light intensity distribution is changed significantly in accordance with the optical-axis position. The laser-light intensity distribution becomes longitudinally asymmetric about the position of a circle of least confusion that corresponds to the light-focusing position. At the optical-axis position −4 to the optical-axis position +2 on the leading side relative to the circle of least confusion, the laser-light intensity distribution has a witch hat shape constituted by an inverted-V-shaped main beam 125 and a bell-mouth-shaped peripheral beam 126 around the main beam 125, the peripheral beam 126 having a light intensity of 200 kW/cm² or lower, and tailing off from the main beam 125. With reference to FIGS. 9 and 10, it is understood that at the optical-axis position −4 to the optical-axis position +2, where the beam shape nearly becomes a witch hat shape, satisfactory machining quality is maintained because the production of the spatters 413 is properly reduced and the surface bead is in a proper state.

From a comprehensive perspective, optimum welding performance is exhibited at the optical-axis position −4 mm, at which a high output of 10 kW and a high welding speed of 5 m/min are achieved, and the generation of the spatters 413 can be properly reduced. Additionally, a smooth weld bead surface is obtained, while the penetration depth reaches a high level of 10.4 mm. Further, over the entire region on the leading side of a beam from the optical-axis position −8 mm to the optical-axis position +2 mm, the spatter amount per 10 cm is reduced to a level of 25±10 spatters or less, which does not cause any problem in practical use. The size of the spatters 413 produced is relatively small at 0.5 mm or less. Adhesion of the spatters 413 onto the surface 40 of the workpiece 4 can also be minimized.

At the optical-axis position −4 mm, the keyhole 50 has a diameter of 0.8 mm, while the peripheral molten pool 52 has a width of 0.6 mm. In order to reduce the spatters 413, it is effective to form the peripheral molten pool 52 with a diameter almost equal to the diameter of the keyhole 50 or with a width of approximately 0.6 mm. At the optical-axis position −4 mm, the light intensity of the peripheral beam 126 gradually decreases from 110 kW/cm² to 7 kW/cm², and the light intensity is 20 kW/cm² at the central portion of the peripheral-beam width. In order to obtain the spatter reduction effect, it is desirable to have an intensity distribution of laser light that continues from the main beam 125 and has a bell-mouth shape that opens upward. A required laser-light intensity for forming a bell-mouth-shaped opening without forming a deep keyhole 50 is equal to or higher than 20 kW/cm² and equal to or lower than 100 kW/cm².

The laser processing machine 100 can reduce generation of the spatters 413 and ensure a high quality processing region over a wide range of optical-axis positions. Because in the high quality processing region, there is a region with a peak beam intensity at the central portion, it is possible to achieve deep penetration. The laser processing machine 100 achieves both high quality processing and high processing performance.

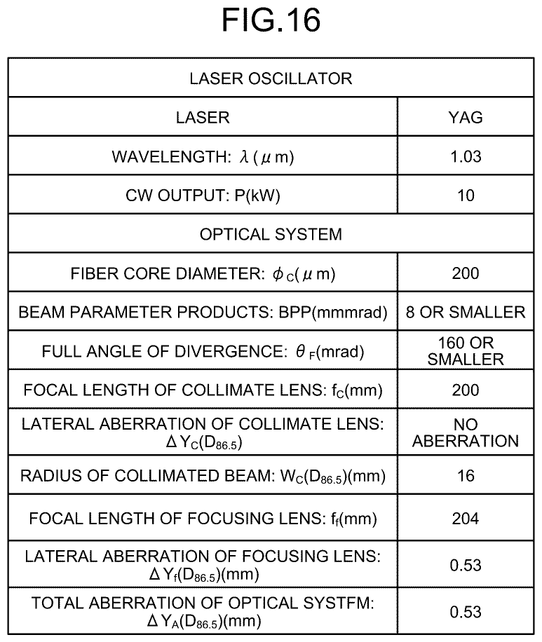

FIG. 16 is a diagram illustrating conditions of the laser oscillator 1 and the optical system of the laser processing machine 100 in the first experiment example of the present invention. The laser oscillator 1 is a disk YAG laser, and outputs a 10 kW laser beam with a wavelength λ=1.03 μm. The conditions of the optical system are that the fiber core diameter φ_{c} of the optical fiber 2 is equal to 200 μm, the beam parameter products BPP is equal to or smaller than 8 mm mrad, and the full angle of divergence θ_{F} is equal to or smaller than 160 mrad.

Next, the conditions of the optical system are described. The collimate lens 31 has a focal length f_{c}=200 mm. The collimate lens 31 is a low-aberration compound lens. The collimate lens 31 is a non-aberration lens. For example, the non-aberration lens can be defined as a lens with a lateral aberration of 0.05 mm or smaller at the light-focusing point with respect to the beam diameter D_{86.5}. In other words, the lateral aberration with respect to the beam diameter D_{86.5} can be regarded as a deviation on the plane perpendicular to the optical axis with respect to a light beam corresponding to the beam diameter D_{86.5}, or can be regarded as a deviation from a circular region within the light beam corresponding to the beam diameter D_{86.5} when this circular region is brought into an optimal light-focusing state. A lens with a larger aberration refers to a lens with an aberration of 0.1 mm or larger with respect to the beam diameter D_{86.5}. In this example, the collimate lens 31 has a lateral aberration ΔYc(D_{86.5}) of 0.05 mm or smaller with respect to an incidence height h=f_{c} tan(−θ_{F}/2)=−16 mm corresponding to the beam diameter D_{86.5}. Because the outline of the region with the beam diameter D_{86.5} is equivalent to the incidence height h=−16 mm, the lateral aberration with respect to the incidence height h=−16 mm is synonymous with a lateral aberration with respect to the beam diameter D_{86.5}.

The light-focusing lens 32 has a focal length f_{f}=204 mm. The light-focusing lens 32 is a compound lens with a large aberration, and has a lateral aberration ΔY_{f}(D_{86.5})=0.53 with respect to the incidence height h=−16 mm corresponding to the angle of divergence ±80 mrad from the optical fiber 2. The collimate lens 31 has an aberration that is small enough to be negligible as compared to the aberration of the light-focusing lens 32. Thus, the lateral aberration ΔY_{A} of the entire optical system can be regarded as equivalent to the lateral aberration ΔY_{f} of the light-focusing lens 32, and is accordingly ΔY_{A}=0.53 mm. The laser processing machine 100 has an aberration that is 10 or more times larger than the aberration of a general processing optical system. In the laser processing machine according to the third comparative example of the present invention illustrated in FIG. 11, the collimate lens 31 and the light-focusing lens 32 are both a low-aberration compound lens with a focal length f=200 mm, and both have a lateral aberration ΔY of 0.05 mm or smaller with respect to the incidence height h=−16 mm.

The processing conditions of welding processing are that the workpiece 4 is made of a soft steel plate material, and the processing speed is 5 m/min. As shield gas, argon gas is sprayed onto the welded portion at the rate of 20 L/min.

As described above, in the first experiment example, specific conditions were clarified for the laser processing machine using a near-infrared laser light source such as a fiber laser or a disk YAG laser to achieve welding processing at a high speed and a high output level of 10 kW with a greater penetration depth, while reducing the spatters 413. The laser processing machine 100 improves the quality of fiber transmission laser welding, and is capable of stabilizing the processing quality.

In the first experiment example described above, the workpiece 4 is assumed to be made of soft steel, that is, made of iron. However, the material of the workpiece 4 is not limited to iron. It is allowable that the workpiece 4 is made of a metal material such as aluminum, copper, nickel, or stainless steel.

In the first experiment example described above, laser processing is performed using a laser beam emitted from the optical fiber 2. However, provided that the aberration condition and the conditions of the main beam 125 and the peripheral beam 126, which have been described in the present embodiment, are satisfied, the technique of the present invention is also applicable to a laser processing machine using a laser beam that does not pass through the optical fiber 2.

In the first experiment example described above, the lenses of the optical system such as the collimate lens 31 and the light-condensing lens 32 have an aberration. It is also allowable that an aberration is generated by the laser oscillator 1 that generates laser light or by the optical fiber 2. That is, it is sufficient that an aberration is generated by at least any of the elements located on the optical path of laser light generated to be irradiated onto the workpiece 4.

### Second Experiment Example

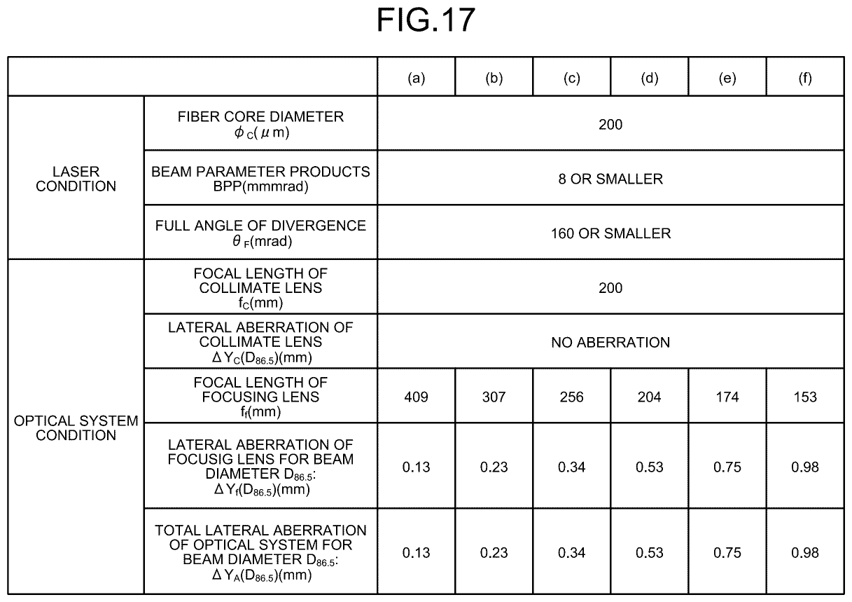

FIG. 17 is a diagram illustrating experiment conditions according to a second experiment example of the present invention. In the second experiment example, in order to identify an aberration condition that is effective to reduce the spatters 413, laser processing was performed under six conditions (a) to (f) with varied aberration amounts of the light-focusing lens 32 in the laser processing machine 100 illustrated in FIG. 1. The processing quality on each of the conditions was then observed.

The conditions (a) to (f) are common in that the collimate lens 31 has a focal length f_{c}=200 mm and a lateral aberration ΔY_{C}(D_{86.5}) of 0.05 mm or smaller with respect to the beam diameter D_{86.5}. The laser conditions in common between the conditions (a) to (f) include the fiber core diameter φ_{c}=200 μm, the beam parameter products BPP=8 mm mrad or smaller, and the full angle of divergence θ_{F}=160 mrad or smaller. Further, the processing speed is 5 m/min and the workpiece 4 is made of a soft steel material.

The light-focusing lens 32 on the condition (a) has a focal length f_{f}=409 mm and a lateral aberration ΔY_{f}(D_{86.5})=0.13 mm with respect to the beam diameter D_{86.5}. The light-focusing lens 32 on the condition (b) has a focal length f_{f}=307 mm and a lateral aberration ΔY_{f}(D_{86.5})=0.23 mm with respect to the beam diameter D_{86.5}. The light-focusing lens 32 on the condition (c) has a focal length f_{f}=256 mm and a lateral aberration ΔY_{f}(D_{86.5})=0.34 mm with respect to the beam diameter D_{86.5}.

The light-focusing lens 32 on the condition (d) has a focal length f_{c}=204 mm and a lateral aberration ΔY_{c}(D_{86.5})=0.53 mm with respect to the beam diameter D_{86.5}. The light-focusing lens 32 on the condition (e) has a focal length f_{c}=174 mm and a lateral aberration ΔY_{c}(D_{86.5})=0.75 mm with respect to the beam diameter D_{86.5}. The light-focusing lens 32 on the condition (f) has a focal length f_{c}=153 mm and a lateral aberration Δ_{Yc}(D_{86.5})=0.98 mm with respect to the beam diameter D_{86.5}. In the second experiment example, the aberration of the collimate lens 31 is small enough to be negligible. Thus, on each of the conditions (a) to (f), the lateral aberration ΔY_{A}(D_{86.5}) of the entire optical system with respect to the beam diameter D_{86.5} can be considered to be equal to the lateral aberration Δ_{Yc}(D_{86.5}) of the light-focusing lens 32.

A laser beam emitted from the optical fiber 2 has a half angle of divergence of 80 mrad corresponding to the beam diameter D_{86.5}. The collimate lens 31 has a focal length f_{c} of 200 mm. This leads to a collimated beam radius Wc(D_{86.5})=f_{c} tan θ_{H}=16 mm corresponding to the beam diameter D_{86.5}. Therefore, the lateral aberration ΔY_{c}(D_{86.5}) of the light-focusing lens 32 is defined as a lateral aberration with respect to the incidence height h=−16 mm at the position corresponding to the beam diameter D_{86.5}. Because the aberration of the light-focusing lens 32 is significantly varied from 0.13 mm to 0.98 mm, lenses with different focal length are used.

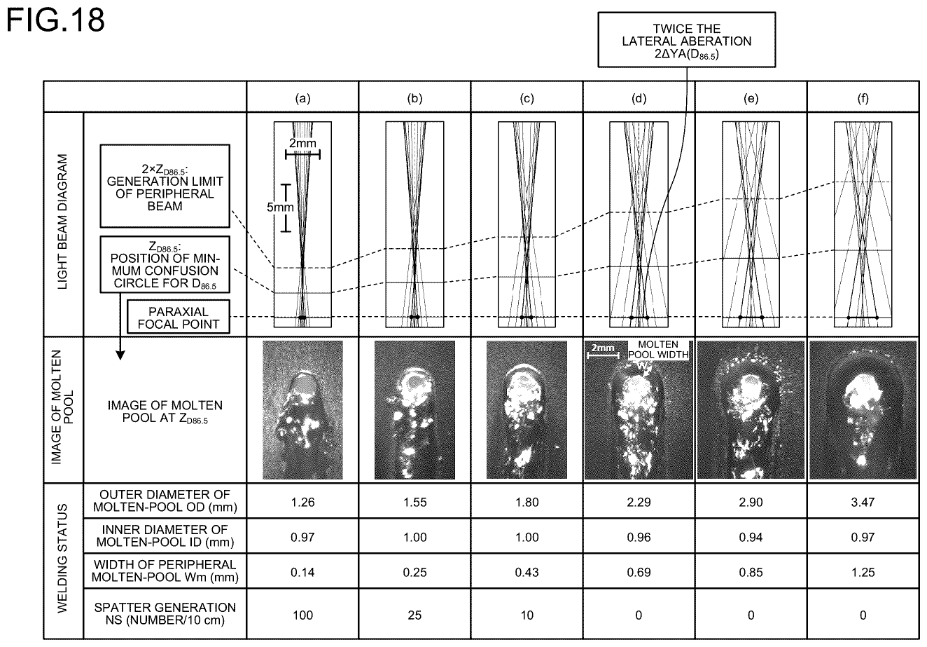

FIG. 18 is a diagram illustrating results of the laser processing performed under the conditions illustrated in FIG. 17. FIG. 18 illustrates a light beam diagram when laser processing is performed under each condition, an image of a molten pool captured during laser processing, and information indicating the status of welding processing. The position appropriate to perform welding processing is set to a position of minimum confusion circle Z_{D86.5} for the beam diameter D_{86.5}. The image of a molten pool captured during laser processing is an image at the position of minimum confusion circle Z_{D86.5}.

The welding status shows values of an outer diameter of molten-pool OD, an inner diameter of molten-pool ID, and a width of peripheral molten-pool Wm, the values having been read from the image of the molten pool. A spatter generation NS indicates the number of spatters generated per welding length of 10 cm.

With reference to FIGS. 17 and 18, it is understood that as the aberration of the entire optical system increases, a group of light beams in the vicinity of the light-focusing position widens, and the width of peripheral molten-pool Wm increases at the position of minimum confusion circle Z_{D89.5} that is the laser processing position.

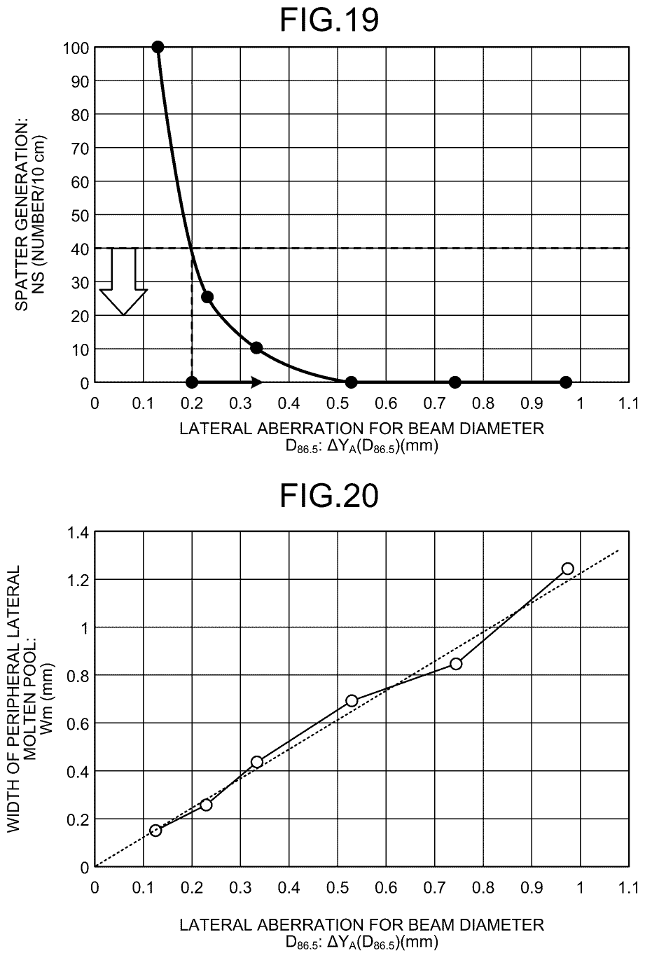

FIG. 19 is a graph illustrating transition of the spatter generation relative to variations in a lateral aberration in the entire optical system illustrated in FIGS. 17 and 18. On the basis of FIG. 19, when the aberration, at which the spatter generation becomes equal to or smaller than 40±10 spatters/10 cm, is assumed to be effective for spatter reduction, the effective lateral aberration ΔY_{A} at the light-focusing point can be considered to fall within the range equal to or larger than 0.2 mm. It is more desirable that the lateral aberration ΔY_{A}(D_{86.5}) at the light-focusing point is equal to or larger than 0.53 mm.

FIG. 20 is a graph illustrating transition of the width of peripheral lateral molten pool Wm when the lateral aberration ΔY_{A}(D_{86.5}) is varied under the conditions illustrated in FIG. 17. It is understood that because the peripheral molten pool 52 is formed by the peripheral beam 126 generated due to the lateral aberration, the width of peripheral lateral molten pool Wm has a strong correlation with the lateral aberration ΔY_{A}(D_{86.5}). The width of peripheral lateral molten pool Wm is proportional to the lateral aberration ΔY_{A}(D_{86.5}), and is 1.2 times larger than the lateral aberration ΔY_{A}(D_{86.5}).

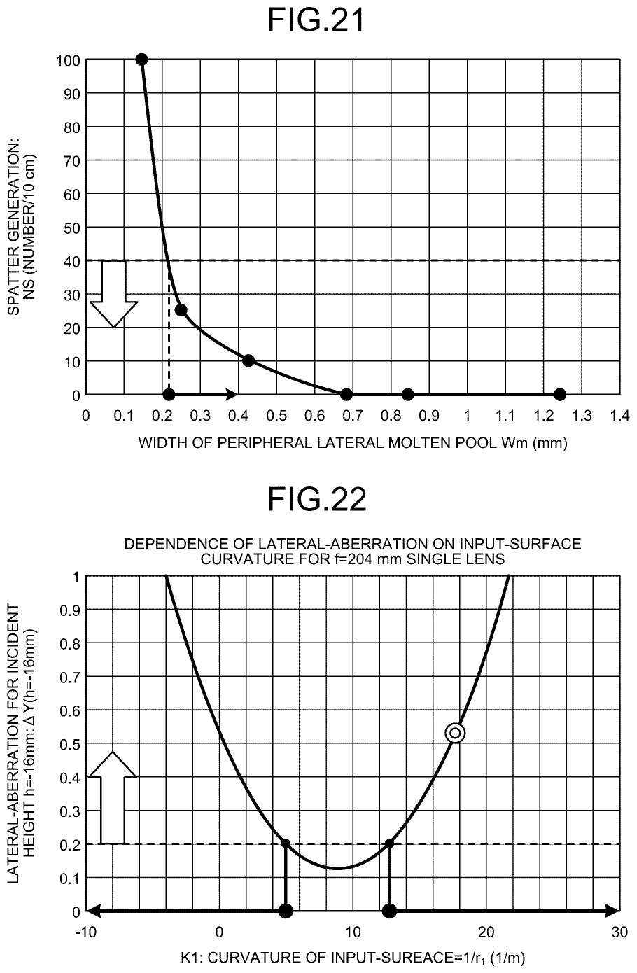

FIG. 21 is a graph illustrating transition of the spatter generation when width of peripheral lateral molten pool Wm illustrated in FIG. 18 is varied. Where the aberration, at which the spatter generation becomes equal to or smaller than 40±10 spatters/10 cm, is defined as bringing the spatters 413 in a reduced state, the width of peripheral lateral molten pool Wm required for spatter reduction is considered to be equal to larger than 0.22 mm. It is more desirable that the width of peripheral lateral molten pool Wm is equal to or greater than 0.69 mm.

### Third Experiment Example

While a compound lens is used as the light-focusing lens 32 in the second experiment example described above, a simple lens is used as the light-focusing lens 32 in a third experiment example of the present invention.

FIG. 22 is a diagram illustrating dependence of lateral-aberration on input-surface curvature for a simple lens to be examined in the third experiment example intended for identifying the characteristics required for the light-focusing lens 32 in FIG. 1. FIG. 22 illustrates transition of the lateral aberration ΔY relative to variations in a curvature of input-surface of a simple lens with a focal length f=204 mm. The glass material of the lens is synthetic quartz, and has a refractive index n=1.45 and a thickness t_{c}=6.5 mm at the central portion of the lens. The lateral aberration calculated by tracking a light beam is derived from a quadratic function that opens upward relative to a curvature of input-surface K1=1/r₁.

The relation between the focal length f of a simple lens, and a radius r₁ of a curvature of input-surface and a radius r₂ of a curvature of output-surface is expressed as the following equation (1). The equation (1) is used to determine the focal length f and the radius r₁ of a curvature of input-surface. The radius r₂ of a curvature of output-surface is then determined, and accordingly the lens shape is determined. Provided that the thickness t_{c} of the lens at its central portion is equal to or smaller than 15 mm, a correlation between the focal length f, the radius r₁ of a curvature of input-surface, and the radius r₂ of a curvature of output-surface has less dependency on the thickness t_{c} of the lens at its central portion.

$$[ Equation 1 ]$$

$$\frac{1}{f} = ( n - 1 ) ( \frac{1}{{r}_{1}} - \frac{1}{{r}_{2}} ) + \frac{{( n - 1 )}^{2}}{n} \frac{1}{{r}_{1}} \frac{1}{{r}_{2}} {t}_{c} \qquad ( 1 )$$

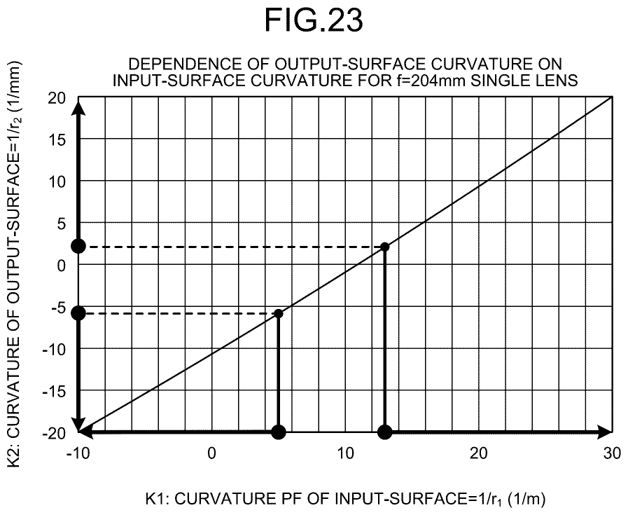

FIG. 23 is a diagram illustrating transition of a curvature of output-surface K2 relative to variations in the curvature of input-surface K1. The value of the curvature of output-surface K2 is calculated using the above equation (1). It is understood that the curvature of output-surface K2 is derived from a linear function with respect to the curvature of input-surface K1, and is less affected by the thickness t_{c} of the lens at its central portion.

As identified in the second experiment example, provided that the aberration condition effective for spatter reduction is set to 0.2 mm or larger, the curvature of input-surface K1 becomes equal to or smaller than 5 m⁻¹ or becomes equal to or larger than 13 m⁻¹. With reference to FIG. 23, when the curvature of input-surface K1 becomes equal to or smaller than 5 m⁻¹, the curvature of output-surface K2 becomes equal to or smaller than −6 m⁻¹, and when the curvature of input-surface K1 becomes equal to or larger than 13 m⁻¹, the curvature of output-surface K2 becomes equal to or larger than 2 m⁻¹.

The lateral aberration ΔYₕ₋₁₆=0.53 mm is set with respect to the incidence height h=−16 mm corresponding to the beam diameter D_{86.5}. This case results in the radius r₁ of a curvature of input-surface=56.3 mm on the incident side of the lens, while resulting in the radius r₂ of a curvature of output-surface=139.9 mm on the light-focusing side of the lens. The thickness t_{c} of the lens at its central portion is set so as to become equal to or greater than 3 mm, at t_{c}=6.5 mm.

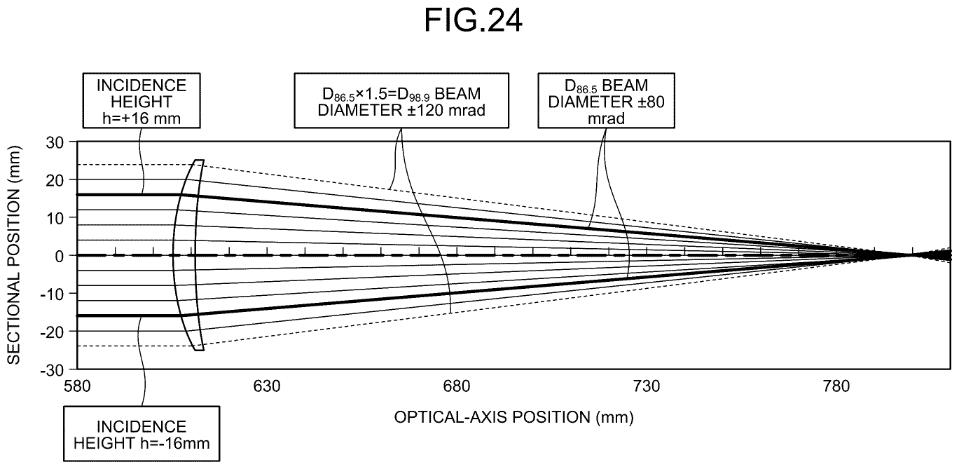

FIG. 24 is a diagram illustrating the shape of the light-focusing lens 32 and light beams according to the third experiment example of the present invention. The light-focusing lens 32 used in the third experiment example has a meniscus shape as illustrated in FIG. 24. In a general optical system, a plano-convex lens, a double-convex lens, or the like is often used in the vicinity of the minimum aberration position in order to obtain high light-focusing performance. In a case where even higher light-focusing performance is required, a compound lens with almost no aberration is used sometimes. In the third experiment example, a lens with a meniscus shape is used in order to generate an aberration of 0.5 mm or larger.

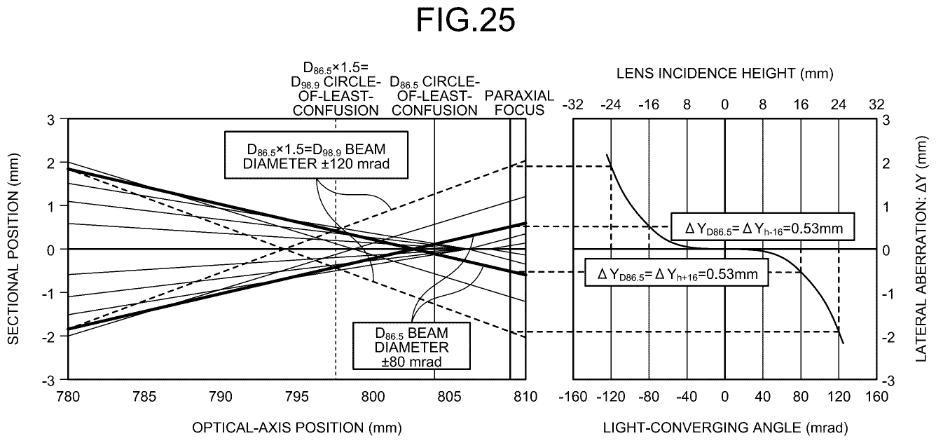

FIG. 25 is a diagram illustrating a partially enlarged view of FIG. 24 and a lateral aberration corresponding to the enlarged view. The incident beam radius W_{86.5} to the light-focusing lens 32 is equal to D_{86.5}/2=16 mm. The incidence height h corresponding to the incident beam radius W_{86.5} is equal to −W_{86.5}=−16 mm. The lateral aberration ΔYₕ₋₁₆ with respect to this incidence height h is equal to 0.53 mm. In order that the amount of aberration is represented as a positive value, the incidence height h is defined as a negative value. The incidence height dependency of the lateral aberration of a simple lens is derived from a cubic function in the area where the incidence height h is smaller than the incidence curvature radius r₁ and the emission curvature radius r₂ of the lens surface.

In the third experiment example, an emission angle from the optical fiber 2 is 80 mrad, and the collimate lens 31 has a focal length f_{c}=200 mm. The aberration with respect to the incidence height h=−16 mm is equivalent to the aberration with respect to the beam diameter D_{86.5}.

As described above, the light-focusing lens 32 has a meniscus shape, so that even a simple lens with a simple structure can still achieve the lateral aberration ΔYₕ₋₁₆=0.53 mm that can generate the peripheral beam 126 that is more effective for spatter reduction.

### Fourth Experiment Example

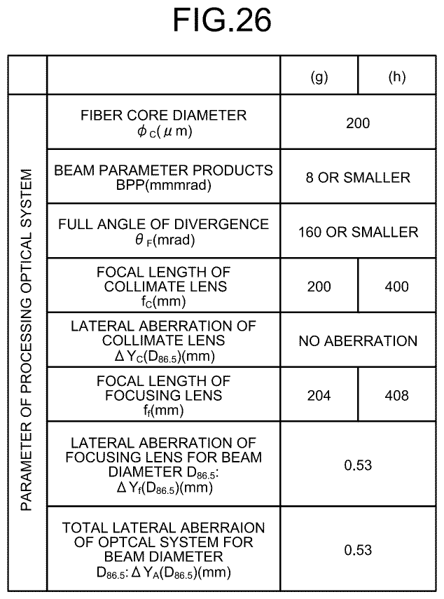

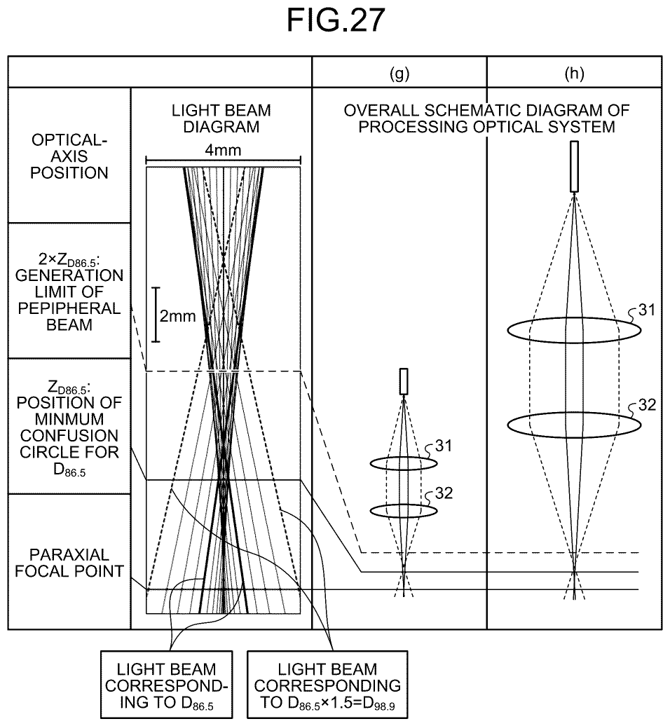

In a fourth experiment example of the present invention, two types of conditions of the processing optical system including the optical fiber 2, the collimate lens 31, and the light-focusing lens 32 are compared to each other and examined. FIG. 26 is a diagram illustrating conditions of the processing optical system according to the fourth experiment example of the present invention. FIG. 27 is a light beam diagram and a schematic configuration diagram of the processing optical system under the conditions illustrated in FIG. 26.

On both conditions (g) and (h) illustrated in FIG. 26, the fiber core diameter φ_{c} of the optical fiber 2 is equal to 200 μm, the beam parameter products BPP is equal to or smaller than 8 mm mrad, and the full angle of divergence θ_{F} is equal to or smaller than 160 mrad. On both the conditions (g) and (h), the collimate lens 31 has a lateral aberration Δ_{Yc}(D_{86.5}) that is small enough to be negligible, and the light-focusing lens 32 has a lateral aberration ΔY_{f}(D_{86.5})=0.53 mm with respect to the beam diameter D_{86.5}. Further, the entire optical system has a lateral aberration ΔY_{A}(D_{86.5})=0.53 mm with respect to the beam diameter D_{86.5}.

On the condition (g), the collimate lens 31 has a focal length f_{c}=200 mm, and the light-focusing lens 32 has a focal length f_{f}=204 mm. On the condition (h), the collimate lens 31 has a focal length f_{c}=400 mm, and the light-focusing lens 32 has a focal length f_{f}=408 mm. When the conditions (g) and (h) are compared, the optical systems have similar figures, and the amounts of lateral aberration corresponding to the light-converging angle are equal. In this case, the light beam diagrams in the vicinity of the focal position correspond with each other in the same light-focusing state.

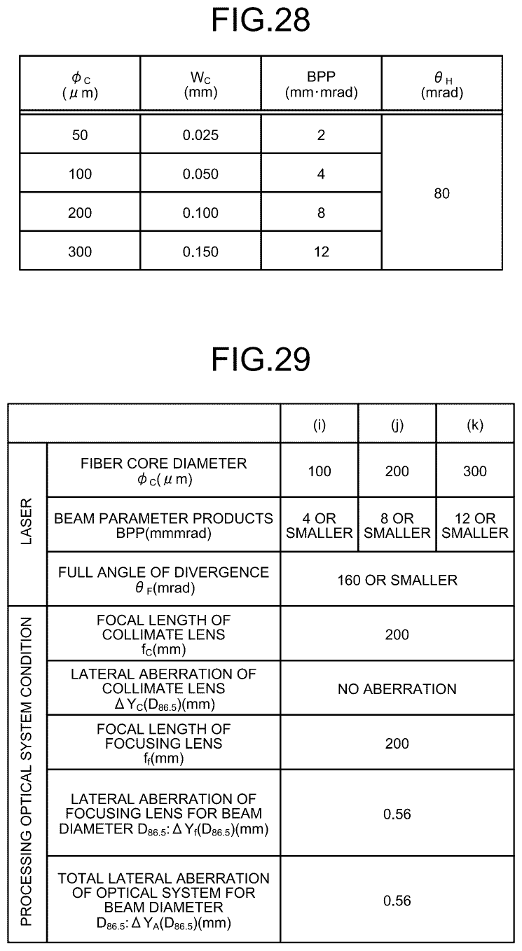

FIG. 28 is a diagram illustrating an example of product specifications of the near-infrared laser light source used in the first to the fourth experiment examples. Product specifications of a fiber laser and a YAG laser, which are used as the near-infrared laser light source, use the de facto standards substantially in common between these fiber and YAG lasers. A half angle of emission θ_{H} from the optical fiber 2 does not depend on the laser output or the fiber diameter of the optical fiber 2, but is set equal to or smaller than 80 mrad. The actual measurement value of the half angle of emission θ_{H} ranges from 75 mrad to 80 mrad.

A uniform half angle of emission θ_{H}=80 mrad or smaller from the optical fiber 2 satisfies the paraxial condition of 5°=87.2 mrad or smaller, so that even a general-purpose optical system can still maintain sufficient light-focusing performance.

### Fifth Experiment Example

In a fifth experiment example of the present invention, dependency of a focused-light intensity distribution on the fiber core diameter φ_{c} is examined. FIG. 29 is a diagram illustrating conditions of the laser processing machine 100 in the fifth experiment example of the present invention. Conditions (i), (j), and (k) are common in all respects except the fiber core diameter φ_{c}.

Specifically, the condition (i) includes the fiber core diameter φ_{c}=100 μm and the beam parameter products BPP=4 mm mrad or smaller. Also, the condition (j) includes the fiber core diameter φ_{c}=200 μm and the beam parameter products BPP=8 mm mrad or smaller. The condition (k) includes the fiber core diameter φ_{c}=300 μm and the beam parameter products BPP=12 mm mrad or smaller. Between the conditions (i), (j), and (k), it is common that the full angle of divergence θ_{F} is equal to or smaller than 160 mrad, the collimate lens 31 has a focal length f_{c}=200 mm, and the collimate lens 31 has a lateral aberration ΔY_{c}(D_{86.5}) that is small enough to be negligible. Further, between the conditions (i), (j), and (k), it is common that the light-focusing lens 32 has a focal length f_{f}=200 mm, and the light-focusing lens 32 has a lateral aberration ΔY_{f}(D_{86.5})=0.56. The entire optical system has a lateral aberration ΔY_{A}(D_{86.5})=0.56.

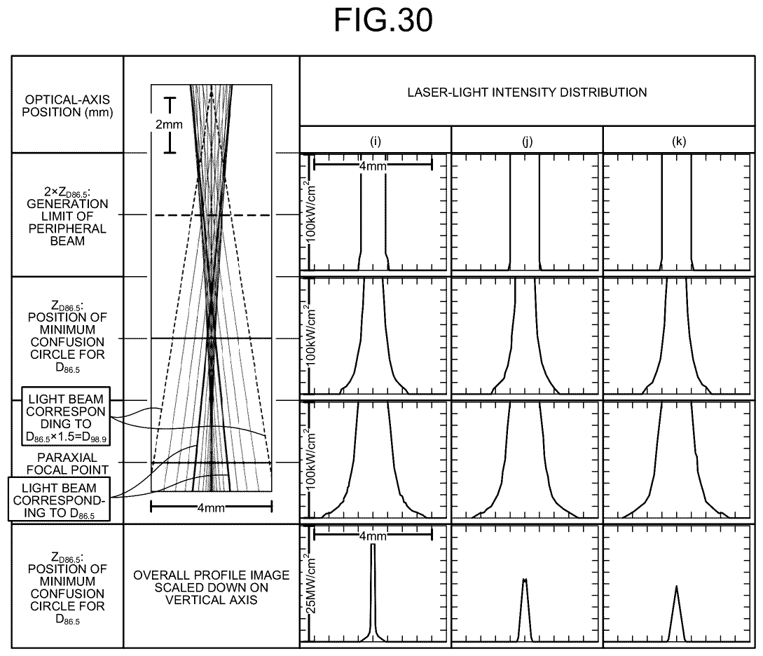

FIG. 30 is a light beam diagram and a diagram illustrating an intensity distribution of laser light emitted by the laser processing machine 100 under each of the conditions illustrated in FIG. 29. In a general low-aberration optical system with a lateral aberration of 0.05 n or smaller, due to magnification transfer of the fiber end at the position of minimum confusion circle to perform processing, the light-focusing diameter varies in proportion to the fiber core diameter φ_{c}.

However, in the laser processing machine 100 according to the fifth experiment example, the lateral aberration with respect to the diameter of a laser beam is 0.2 mm or larger, and is accordingly 0.4 mm or larger in diameter, and more desirably, the lateral aberration is 0.5 mm or larger, and is accordingly 1.0 mm or larger in diameter. These values are relatively large for an aberration because the lateral aberration exhibits a one-fold to a 20-fold or greater increase relative to the fiber core diameter φ_{c} that increases from 0.1 mm to 0.3 mm. For this reason, the light intensity distribution in the vicinity of the light-focusing point is predominantly affected by the aberration of the optical system, and is less affected by the fiber core diameter pc.

With reference to FIG. 30, when the fiber core diameter φ_{c} is varied, the light intensity at the central portion varies significantly. As the fiber core diameter φ_{c} is decreased to one-third from 300 μm to 100 μm, the light intensity at the central portion increases from 11.8 MW/cm² to 39.8 MW/cm². In a general non-aberration optical system, as the fiber core diameter P_{c} is decreased to one-third, the spot diameter at the light-focusing point is also decreased to one-third, and the light intensity at the central portion becomes nine times higher accordingly. In contrast to this, in the fifth experiment example, the light intensity at the central portion maintains an approximately 3.4-fold increase due to the influence of aberration.

In order to reduce the spatters 413, it is important for the peripheral beam 126 to have a light intensity equal to or lower than 200 kW/cm² and have a width equal to or greater than 0.3 mm. With reference to FIG. 30, although the fiber core diameter φ_{c} is varied, this exerts only an insignificant influence on the intensity distribution of the peripheral beam 126. Even though the fiber core diameter φ_{c} is varied from 0.1 mm to 0.3 mm, the intensity of the peripheral beam 126 remains almost unchanged, and dependency on the optical-axis position also remains unchanged.

### Sixth Experiment Example

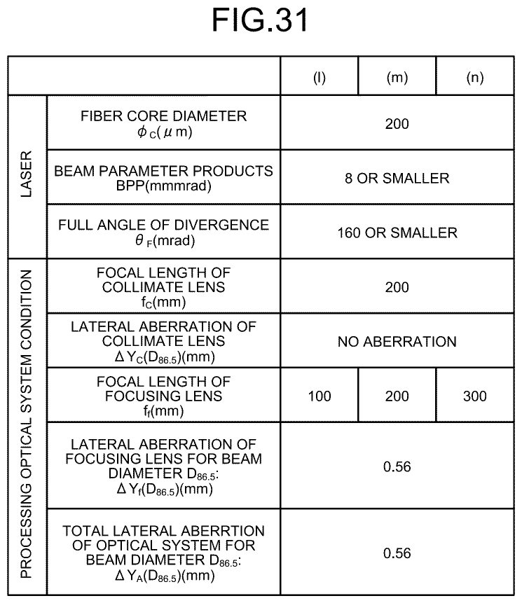

In a sixth experiment example of the present invention, dependency of a light intensity distribution on variations in the focal length f_{f} of the light-focusing lens 32 is examined. FIG. 31 is a diagram illustrating conditions of the laser processing machine 100 in the sixth experiment example of the present invention.

Conditions (1), (m), and (n) illustrated in FIG. 31 are the same as the condition (j) illustrated in FIG. 29 except for the focal length f_{f} of the light-focusing lens 32. On the condition (1), the light-focusing lens 32 has a focal length f_{f}=100 mm. On the condition (m), the light-focusing lens 32 has a focal length f_{f}=200 mm. On the condition (n), the light-focusing lens 32 has a focal length f_{f}=300 mm.

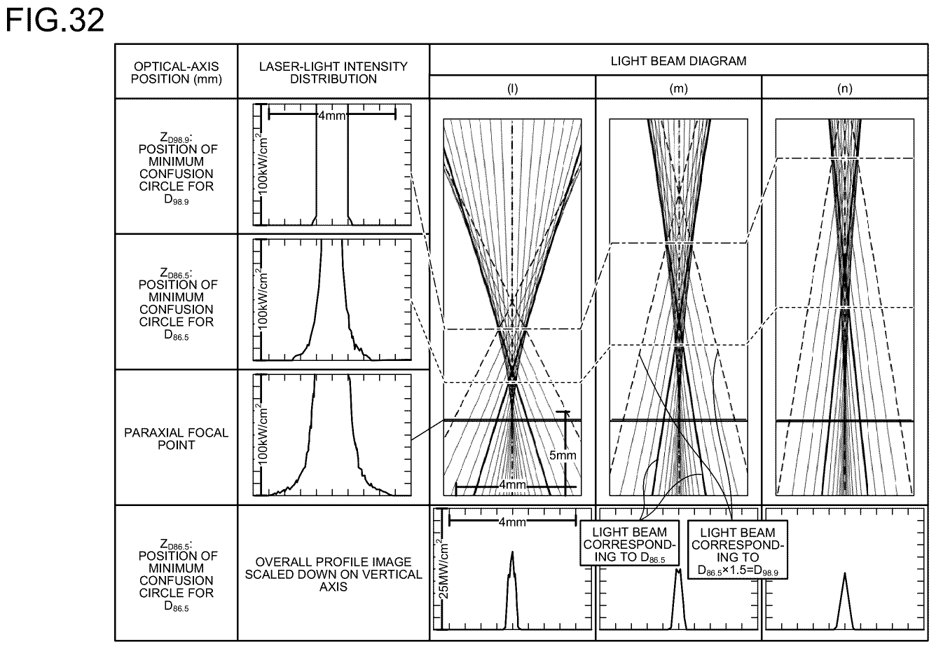

FIG. 32 is a light beam diagram and a diagram illustrating an intensity distribution of laser light emitted by the laser processing machine 100 under each of the conditions illustrated in FIG. 31. With reference to FIG. 32, even when the light-converging angle is varied by varying the focal length f_{f}, there are only insignificant variations in the light-focusing state and in the light intensity distribution at the paraxial focal position, at the position of minimum confusion circle for D_{86.5}, and at the position of minimum confusion circle for D_{98.9}.

As the light-converging angle is varied by varying the focal length f_{f}, a basic spot diameter φₛ determined by an optical magnification α=(f_{f}/fₑ) is varied in accordance with the following equation (2). However, there are only insignificant variations in the light intensity distribution of the peripheral beam 126.

φₛ=(f_{f}/f_{c})·φ_{F}=BPP/θₛ (2)

In the equation (2), φ_{F} represents the fiber core diameter.

When the light beam diagrams in FIG. 32 are compared, it is understood that with variations in the focal length, that is, with variations in the light-converging angle, the scale in the optical-axis direction, such as a spacing between the focal point and each of the minimum confusion circle, is varied in proportion to the focal length. However, with reference to the diagrams illustrating the light intensity distribution in FIG. 32, it is understood that the intensity distributions of the peripheral beam 126 at the respective positions are similar, and the same spatter reduction effect can be obtained. The processing position likelihood equivalent to the focal depth in the optical-axis direction, and the like are varied with variations in the focal length.

It is understood from the above fifth experiment example and the sixth experiment example that in an optical system with a larger aberration, even when the fiber diameter of the optical fiber 2 is varied, or even when the focal length is varied, the light intensity distributions are still similar as long as the aberrations with respect to the light-beam position corresponding to the beam diameter D_{86.5} are equal. It is thus understood that the aberration with respect to the beam diameter D_{86.5}, that is, the aberration with respect to the light beam position corresponding to the beam diameter D_{86.5} is set, and thereby similar light intensity distributions can be obtained and it is possible to obtain the same spatter reduction effect. Dependency of the light intensity distribution on the optical-axis position is increased or decreased in accordance with the focal length.

### Seventh Experiment Example

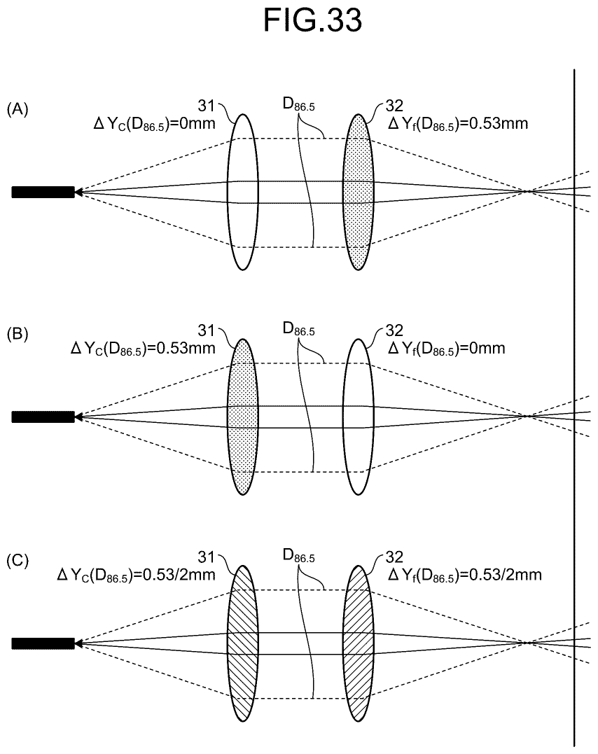

In a seventh experiment example of the present invention, an influence, to be exerted by using different aberration-generating elements within the light-focusing optical system 3, is examined. FIG. 33 is a diagram illustrating conditions of an aberration of each lens in the seventh experiment example of the present invention.

On a condition (A) in FIG. 33, the collimate lens 31 is a low-aberration compound lens with a lateral aberration ΔY_{c}(D_{86.5})=0 mm, and the light-focusing lens 32 has a lateral aberration ΔY_{f}(D_{86.5})=0.53 mm. On a condition (B), the collimate lens 31 has a lateral aberration ΔY_{c}(D_{86.5})=0.53 mm, and the light-focusing lens 32 is a low-aberration lens with a lateral aberration ΔY_{f}(D_{86.5})=0 mm. Further, on a condition (C), the collimate lens 31 has a lateral aberration ΔY_{c}(D_{86.5})=0.265 mm, and the light-focusing lens 32 has a lateral aberration ΔY_{f}(D_{86.5})=0.265 mm.

When simulation is performed under the three conditions (A), (B), and (C) illustrated in FIG. 33, the entire aberration of the light-focusing optical system 3 is a total of the aberrations of both the lenses, and thus the total aberration is equal on each of the three conditions. It was understood that because the light intensity distribution at the light-focusing point is determined in accordance with the entire aberration of the light-focusing optical system 3, there is not a significant difference in the light intensity distribution at the light-focusing point between the three conditions (A), (B), and (C), and a similar spatter reduction effect is obtained.

In general, an aberration of the light-focusing optical system 3 is defined for the light-focusing point in the laser-beam traveling direction. However, an aberration is defined for the collimate lens 31 that collimates light emitted from the optical fiber 2 on the basis of virtual light of a collimated beam that is reversely incident from a collimating portion facing opposite to the travelling direction and that is focused toward an output end of the optical fiber 2.

### Eighth Experiment Example

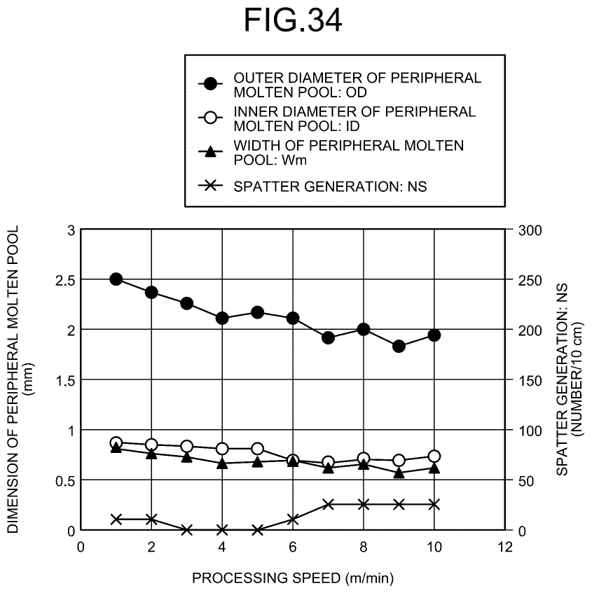

In an eighth experiment example of the present invention, the state of a molten pool and the reduction state of the spatters 413 under the same optical conditions were examined, where the processing speed was changed from 1 m/min to 10 m/min on a 1 m/min basis. FIG. 34 is a diagram illustrating experiment results of the eighth experiment example of the present invention.

With reference to FIG. 34, as the processing speed increases, the molten-pool outer diameter OD of the peripheral molten pool 52 gradually decreases, and becomes 2.5 mm at 1 m/min, 2.2 mm at 5 m/min, and 1.9 mm at 10 m/min. In contrast to this, the molten-pool inner diameter ID of the peripheral molten pool 52, that is, the diameter φ_{KH} of the keyhole 50 is almost constant within the range of 0.75±0.15 mm.

As the processing speed increases, the peripheral molten-pool width Wm decreases from 0.75 mm to 0.45 mm, while being maintained at a width equal to or greater than 0.22 mm that is effective for spatter reduction. Thus, the spatter generation NS is reduced to a level of 0 to 25 spatters/10 cm over the entire speed range. It is therefore understood that the laser processing machine 100 achieves the effect of reducing the spatters 413 regardless of the processing speed.

### Ninth Experiment Example

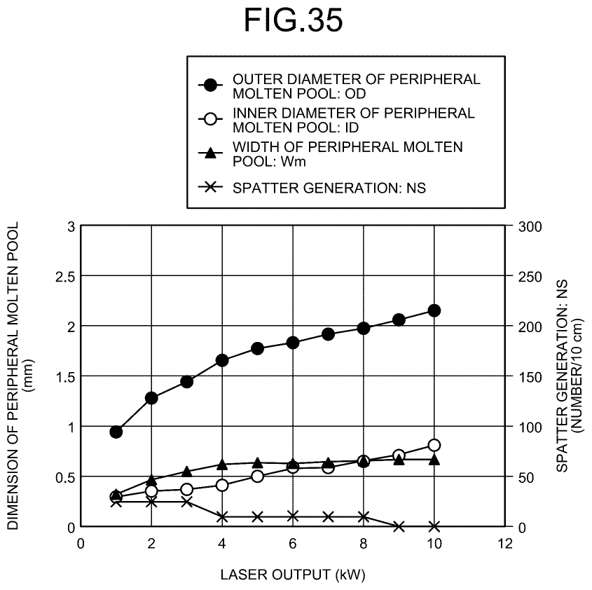

In a ninth experiment example of the present invention, the state of a molten pool and the reduction state of the spatters 413 were examined, where the laser output was changed from 1 kW to 10 kW on a 1 kW basis. FIG. 35 is a diagram illustrating experiment results of the ninth experiment example of the present invention.

With reference to FIG. 35, while the peripheral molten pool 52 and the keyhole 50 become smaller with a decrease in output, the spatter generation NS is reduced to a level of 0 to 10 spatters/10 cm over the entire output range from 1 kW to 10 kW. It is therefore understood that the laser processing machine 100 achieves the effect of reducing the spatters 413 regardless of the laser output.

On the basis of the experiment results of the first to the ninth experiment examples described above, conditions for laser processing using a near-infrared laser to reduce the spatters 413 and thus achieve high quality processing were clarified. High quality processing can be achieved by having an optical system with an aberration on an optical path of laser light generated and reaching the processing position, and by setting a lateral aberration at the light-focusing point to 0.2 mm or larger relative to the beam diameter D_{86.5}. The lateral aberration of 0.2 mm or larger relative to the beam diameter D_{86.5} indicates that a lateral aberration is equal to or larger than 0.2 mm with respect to the light beam containing 86.5% of laser power and corresponding to the beam diameter of the light before being focused. Because the spatters 413 are more likely to be produced on the trailing side in the laser-light scanning direction, it is desirable that at least a lateral aberration of the above lateral aberration, which is generated on the trailing side in the laser-light scanning direction, satisfies the above conditions. By generating the aberration as described above, the beam shape at the light-focusing point becomes a witch hat shape, and the peripheral beam 126 with a light intensity equal to or higher than 5 kW/cm² and equal to or lower than 200 kW/cm² has a width of 0.22 mm or greater. When the peripheral beam 126 as described above is formed, this generates an evaporation reaction force so as to change the direction of the molten metal flow 411 from a vertical direction to a horizontal direction to the surface of the workpiece 4. This can reduce the production of the spatters 413.

When light emitted from the optical fiber 2 is focused by the light-focusing optical system 3, the beam diameter D_{86.5} corresponds to the angle of divergence ±80 mrad from the optical fiber 2. For this reason, the above condition can also be rephrased as a lateral aberration at the light-focusing point being 0.2 mm or larger relative to the angle of divergence ±80 mrad from the optical fiber 2.

Further, it is allowable that the aberration of the light-focusing optical system 3 consists of an aberration of the collimate lens 31, or consists of an aberration of the light-focusing lens 32. It is also allowable that both the collimate lens 31 and the light-focusing lens 32 have an aberration. When both the collimate lens 31 and the light-focusing lens 32 have an aberration, it is sufficient that a total of the aberrations of the collimate lens 31 and the light-focusing lens 32 satisfies the above condition.

In addition to the above condition, a half angle of light converging corresponding to the beam diameter D_{86.5} is set equal to or larger than 50 mrad and equal to or smaller than 110 mrad. Consequently, in contrast to a laser beam emitted from a general optical fiber 2 at a half angle of emission 80 mrad, a virtual core spot diameter assuming that there is no aberration can be increased 0.625-fold to 1.375-fold from the emission fiber diameter. This can exhibit deep penetration performance.

### Second Embodiment

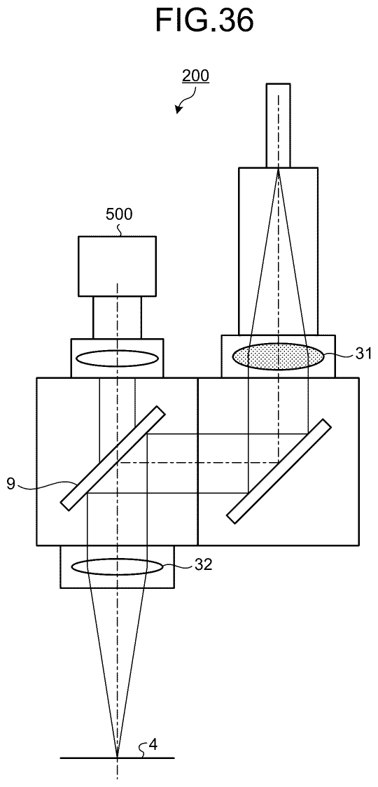

FIG. 36 is a diagram illustrating a configuration of a laser processing machine 200 according to a second embodiment of the present invention. The laser processing machine 200 according to the second embodiment includes a capturing device 500 that monitors the workpiece 4 during laser processing.

The laser processing machine 200 includes the collimate lens 31 having an aberration and the light-focusing lens 32 that is a low-aberration lens. A bend mirror 9 is located on an optical path between the collimate lens 31 and the light-focusing lens 32. The bend mirror 9 reflects light from the collimate lens 31 onto the light-focusing lens 32. The capturing device 500 that is a capturing unit is a coaxial camera, and can detect light traveling linearly through the light-focusing lens 32 and the bend mirror 9.

Because the light-focusing lens 32 does not have an aberration, distortion of a monitor image of the capturing device 500 can be minimized. Therefore, it is possible to coaxially monitor a clear image of a portion of the workpiece 4 undergoing laser processing without blurriness or distortion, while reducing the spatters 413 and thus minimizing degradation in the processing quality.

The configurations described in the above embodiments are only examples of the content of the present invention. The configurations can be combined with other well-known techniques, and part of each of the configurations can be omitted or modified within a range not departing from the scope of the present invention.

For example, while the laser processing machine 100 using a near-infrared laser has been described above, the present invention is not limited to this example. The techniques described in the embodiments of the present invention are also effective even when applied to a laser processing machine using, for example, a visible-light laser or a mid-infrared laser.

In the above embodiments, the laser processing machine 100 and the laser processing machine 200, each of which includes the optical fiber 2 and the light-focusing optical system 3 that focuses a laser beam emitted from the optical fiber 2, have been described. However, the present invention is not limited to these examples. The technique of the present invention is also applicable to a laser processing machine that does not include the optical fiber 2. It is allowable that light emitted from the laser oscillator 1 is incident directly to the light-focusing optical system 3. Any optical element may be located on an optical path of light emitted from the laser oscillator 1 and incident to the light-focusing optical system 3 without departing from the scope of the present invention.

### REFERENCE SIGNS LIST

1 laser oscillator, 2 optical fiber, 3 light-focusing optical system, 4 workpiece, 7 evaporation reaction force, 9 bend mirror, 10 emitted beam, 10a, 11a, 12a, 91a beam shape, 11 collimated light, 12, 91, 92 focused light beam, 31 collimate lens, 32 light-focusing lens, 40 surface, 41 molten metal, 50 keyhole, 51 opening, 60, 61 metal steam, 100, 200 laser processing machine, 125 main beam, 126 peripheral beam, 411 molten metal flow, 500 capturing device, 502 keyhole inner wall.

1. A laser processing method, comprising:
emitting, by a laser oscillator, a laser beam; and
focusing, by a light-focusing optical system, the laser beam, wherein
a beam parameter products of the laser beam emitted from the laser oscillator is 12 mm mrad or smaller when the laser beam is incident to the light-focusing optical system,
a light intensity at the central portion of the laser beam is 4 MW/cm² or higher at the light-focusing point of the light-focusing optical system,
the light-focusing optical system has an aberration which includes a lateral aberration with respect to a laser beam diameter:D_{86.5} containing 86.5% of the laser power of the laser beam before being focused, that is 0.2 mm or more,
the lateral aberration is at a light focusing point corresponding to the laser beam diameter:D_{86.5}, and
the laser beam has an intensity distribution with an inverted V-shape at an irradiating position of the laser beam onto the workpiece, the inverted V-shape having a maximum amplitude at a center of the intensity distribution.

2. The laser processing method according to claim 1, further comprising transmitting, by an optical fiber, the laser beam, wherein the light-focusing optical system focuses the laser beam emitted from the optical fiber.

3. A laser processing method to process a workpiece by focusing a laser beam onto the workpiece, the method comprising:
irradiating the laser beam onto the workpiece, the laser beam having an intensity distribution with an inverted V-shape at an irradiating position, the inverted V-shape constituted by a main beam having a peak light intensity of 4 MW/cm² or higher and a peripheral beam having a lower intensity than the main beam and extending from the main beam,
wherein the main beam has a diameter of 0.5 mm or smaller at any light intensity of 1 MW/cm² or higher, and the peripheral beam has a width of 0.22 mm or greater on a plane perpendicular to an optical axis at any light intensity equal to or higher than 5 kW/cm² and equal to or lower than 200 kW/cm², and
wherein the inverted V-shape has a maximum amplitude at a center of the irradiating position.

4. A laser processing method to process a workpiece by focusing a laser beam onto the workpiece, the method comprising:
irradiating the laser beam onto the workpiece, the laser beam having an intensity distribution with an inverted V-shape at an irradiating position, the inverted V-shape constituted by a main beam having a peak light intensity of 4 MW/cm² or higher and a peripheral beam having a lower intensity than the main beam and extending from the main beam,
wherein a peripheral molten pool is formed on the workpiece responsive to the irradiating, the peripheral molten pool being shallower than a keyhole formed by the main beam, surrounding the keyhole, and having a width of 0.22 mm or greater, and
wherein the inverted V-shape has a maximum amplitude at a center of the intensity distribution.
